(19) United States
(12) Patent Application Publication
(10) Pub. No.: US 2026/0046448 A1
(43) Pub. Date: Feb. 12, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Lei ZHAO, Beijing (CN); Kai Zhang, Los Angeles, CA (US); Na Zhang, Beijing (CN); Yang Wang, Beijing (CN); Li Zhang, Los Angeles, CA (US)

(21) Appl. No.: 19/362,121

(22) Filed: Oct. 17, 2025

Related U.S. Application Data
(63) Continuation of application No. PCT/CN2024/088944, filed on Apr. 19, 2024.

(30) Foreign Application Priority Data
Apr. 20, 2023 (WO) PCT/CN2023/089550

(51) Int. Cl. H04N 19/593; H04N 19/11; H04N 19/132; H04N 19/139; H04N 19/176; H04N 19/70

(52) U.S. Cl. CPC H04N 19/593; H04N 19/11; H04N 19/132; H04N 19/139; H04N 19/176; H04N 19/70

(57) ABSTRACT

Embodiments of the present disclosure provide a solution for video processing. A method for video processing is proposed. In the method, for a conversion between a target video block of a video and a bitstream of the video, a first prediction of the target video block is determined based on a first block vector (BV). A final prediction of the target video block is determined based on the first prediction and a second prediction of the target video block. The second prediction is determined based on at least one of: a second BV, a motion vector (MV), or an intra prediction. The conversion is performed based on the final prediction.

### CROSS REFERENCE TO RELATED APPLICATIONS

This application is a continuation of International Application No. PCT/CN2024/088944, filed on Apr. 19, 2024, which claims the benefit of International Application No. PCT/CN2023/089550 filed on Apr. 20, 2023. The entire contents of these applications are hereby incorporated by reference in their entireties.

### FIELDS

Embodiments of the present disclosure relates generally to video processing techniques, and more particularly, to intra block copy (IBC) with a plurality of predictions.

### BACKGROUND

In nowadays, digital video capabilities are being applied in various aspects of peoples' lives.

Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a target video block of a video and a bitstream of the video, a first prediction of the target video block based on a first block vector (BV); determining a final prediction of the target video block based on the first prediction and a second prediction of the target video block, the second prediction being determined based on at least one of: a second BV, a motion vector (MV), or an intra prediction; and performing the conversion based on the final prediction. The method in accordance with the first aspect of the present disclosure determines the final prediction of the target video block based on a prediction from a BV and a further prediction from a further BV or a MV or an intra prediction, and thus improves the coding.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a first prediction of a target video block of the video based on a first block vector (BV); determining a final prediction of the target video block based on the first prediction and a second prediction of the target video block, the second prediction being determined based on at least one of: a second BV, a motion vector (MV), or an intra prediction; and generating the bitstream based on the final prediction.

In a fifth aspect, another non-transitory computer-readable recording medium is proposed. The non-transitory computer-readable recording medium stores a bitstream of a video which is generated by a method performed by an apparatus for video processing. The method comprises: determining a first prediction of a target video block of the video based on a first block vector (BV); determining a final prediction of the target video block based on the first prediction and a second prediction of the target video block, the second prediction being determined based on at least one of: a second BV, a motion vector (MV), or an intra prediction; generating the bitstream based on the final prediction; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates positions of spatial and temporal neighboring blocks used in AMVP/merge candidate list construction;

FIG. 5 illustrates positions of non-adjacent candidate in ECM;

FIG. 6 illustrates control point based affine motion model;

FIG. 7 illustrates an example affine MVF per subblock;

FIG. 8 illustrates locations of inherited affine motion predictors;

FIG. 9 illustrates control point motion vector inheritance;

FIG. 10 illustrates locations of Candidates position for constructed affine merge mode;

FIG. 11 illustrates spatial neighbors for deriving affine merge candidates;

FIG. 12 illustrates from non-adjacent neighbors to constructed affine merge candidates;

FIG. 13 illustrates an example of generating an HAPC;

FIG. 14 illustrates an illustration of regression based affine merge candidate derivation;

FIG. 15 illustrates template matching performs on a search area around initial MV;

FIG. 16 illustrates template and the corresponding reference template;

FIG. 17 illustrates template and reference template for block with sub-block motion using the motion information of the subblocks of current block;

FIG. 18 illustrates deriving sub-CU motion field obtained by applying a motion shift based on the neighboring motion information;

FIG. 19 illustrates current CTU processing order and its available reference samples in current and left CTU;

FIG. 20 illustrates an illustration of the extended reference area;

FIG. 21 illustrates an example IBC reference region depending on current CU position;

FIG. 22 illustrates examples of symmetry in screen content pictures;

FIG. 23A illustrates an illustration of BV adjustment for horizontal flip;

FIG. 23B illustrates an illustration of BV adjustment for vertical flip;

FIG. 24 illustrates a flowchart of a method for video processing in accordance with embodiments of the present disclosure; and

FIG. 25 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

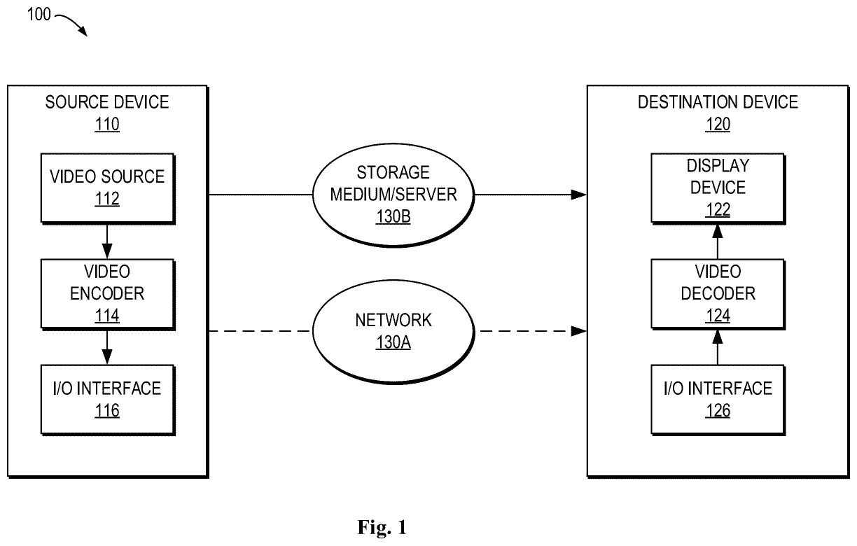

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

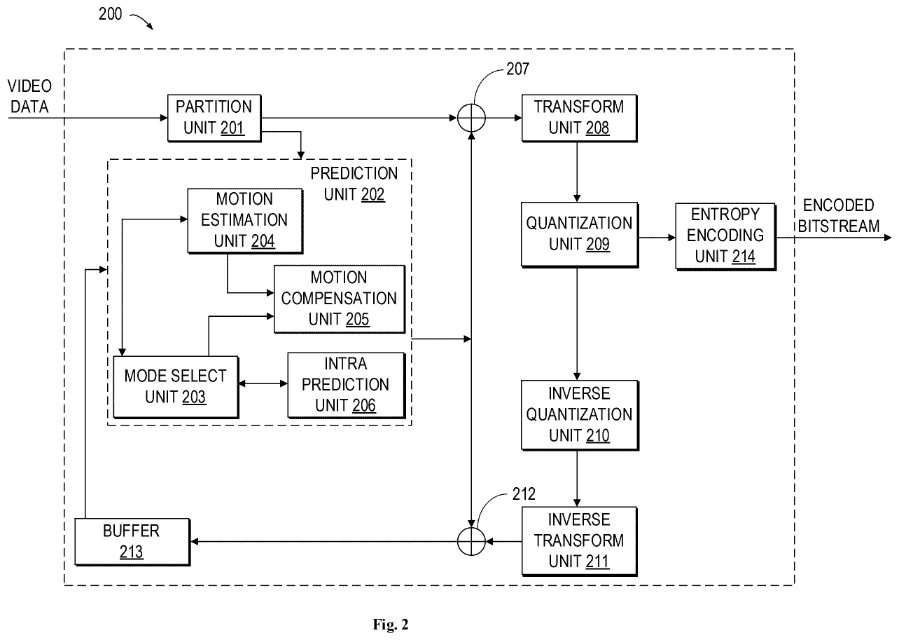

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components.

The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block.

The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

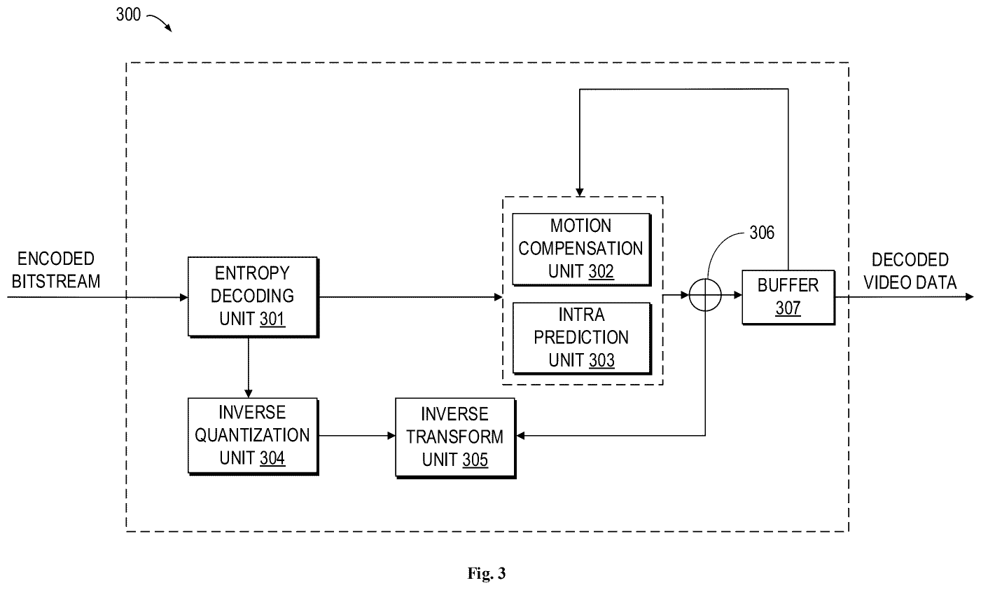

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about Affine motion prediction method in video coding. The ideas may be applied individually or in various combination, to any video coding standard or non-standard video codec.

### 2. Introduction

The exponential increasing of multimedia data poses a critical challenge for video coding. To satisfy the increasing demands for more efficient compression technology, ITU-T and ISO/IEC have developed a series of video coding standards in the past decades. In particular, the ITU-T produced H.261 and H.263, ISO/IEC produced MPEG-1 and MPEG-4 visual, and the two organizations jointly developed the H.262/MPEG-2 Video, H.264/MPEG-4 Advanced Video Coding (AVC), H.265/HEVC and the latest VVC standards. Since H.262/MPEG-2, hybrid video coding framework is employed wherein in intra/inter prediction plus transform coding are utilized.

2.1. MVP in Video Coding Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC, competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, a MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.

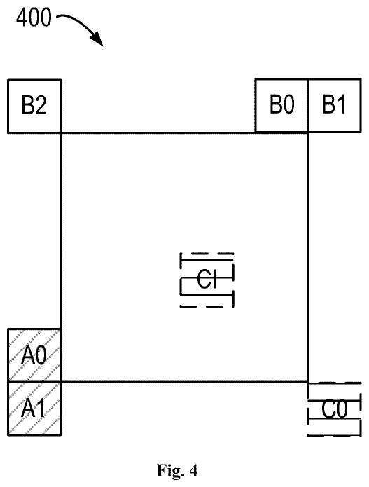

AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. FIG. 4 illustrates positions of spatial and temporal neighboring blocks used in AMVP/merge candidate list construction. For spatial motion vector candidate derivation, two motion vector candidates are eventually derived based on motion vectors of blocks located in five different positions as depicted in FIG. 1. The five neighboring blocks located at B0, B1, B2, and A0, A1 are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different collocated positions (bottom-right (C0) and central (C1)) checked in order, as depicted in FIG. 1. To avoid redundant MV candidates, duplicated motion vector candidates in the list are abandoned. If the number of potential candidates is smaller than two, additional zero motion vector candidates are added to the list.

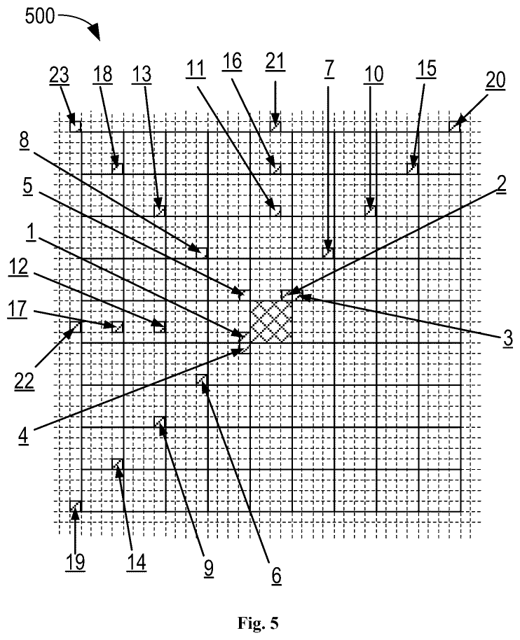

FIG. 5 illustrates positions of non-adjacent candidate in ECM.

Merge mode: Similar to AMVP mode, MVP candidate list for merge mode comprises of spatial and temporal candidates as well. For spatial motion vector candidate derivation, at most four candidates are selected with order A1, B1, B0, AG and B2 after performing availability and redundant checking. For temporal merge candidate (TMVP) derivation, at most one candidate is selected from two temporal neighboring blocks (C0 and C1). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.

In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP.

In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.

During the standardization of VVC, Non-adjacent MVP was proposed to facilitate better motion information derivation by exploiting the non-adjacent area. In ECM software, Non-adjacent MVP are inserted between TMVP and HMVP, where the distances between non-adjacent spatial candidates and current coding block are based on the width and height of current coding block as depicted in FIG. 2.

### 2.2. Affine Motion Compensated Prediction

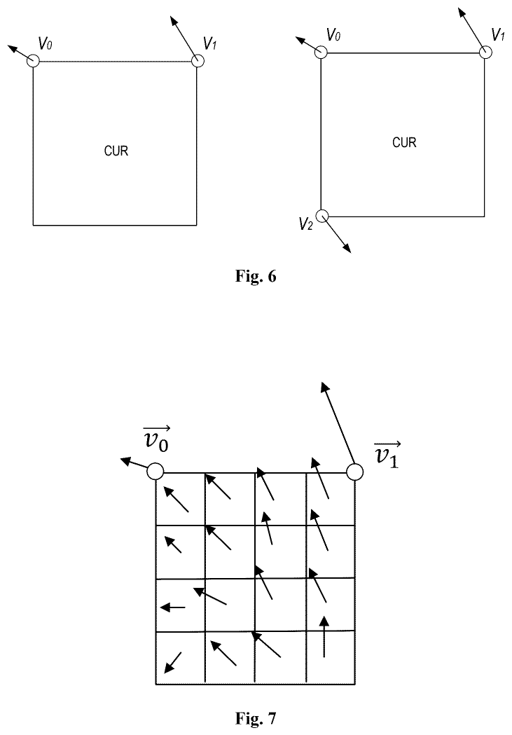

In HEVC, only translation motion model is applied for motion compensation prediction (MCP). While in the real world, there are many kinds of motion, e.g., zoom in/out, rotation, perspective motions and the other irregular motions. In VVC, a block-based affine transform motion compensation prediction is applied. FIG. 6 illustrates control point based affine motion model, for example (a) 4 parameter affine model and (b) 6 parameter affine model. As shown in FIG. 6, the affine motion field of the block is described by motion information of two control point (4-parameter) or three control point motion vectors (6-parameter).

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} . \qquad ( 1 )$$

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} . \qquad ( 2 )$$

Where (mv0x, mv0y) is motion vector of the top-left corner control point, (mv1x, mv1y) is motion vector of the top-right corner control point, and (mv2x, mv2y) is motion vector of the bottom-left corner control point. To simplify the motion compensation prediction, block based affine transform prediction is applied. FIG. 7 illustrates an example affine MVF per subblock. To derive motion vector of each 4×4 luma subblock, the motion vector of the center sample of each subblock, as shown in FIG. 7, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

2.2.1. Affine Merge Prediction Affine merge mode can be applied for CUs with both width and height larger than or equal to 8. In this mode the CPMVs of the current CU is generated based on the motion information of the spatial neighboring CUs. There can be up to five CPMVP candidates and an index is signalled to indicate the one to be used for the current CU.

In VVC, the following three types of CPVM candidate are used to form the affine merge candidate list:
Inherited affine merge candidates that extrapolated from the CPMVs of the neighbour CUs.
Constructed affine merge candidates CPMVPs that are derived using the translational MVs of the neighbour CUs.
Zero MVs.

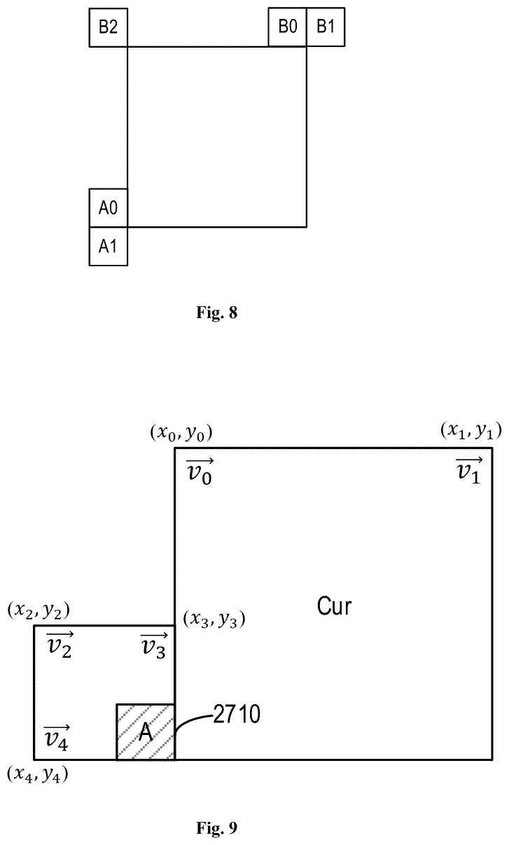

In VVC, there are maximum two inherited affine candidates, which are derived from affine motion model of the neighboring blocks, one from left neighboring CUs and one from above neighboring CUs. FIG. 8 illustrates locations of inherited affine motion predictors. The candidate blocks are shown in FIG. 8. For the left predictor, the scan order is A0->A1, and for the above predictor, the scan order is B0->B1->B2. Only the first inherited candidate from each side is selected. No pruning check is performed between two inherited candidates. When a neighboring affine CU is identified, its control point motion vectors are used to derive the CPMVP candidate in the affine merge list of the current CU. FIG. 9 illustrates control point motion vector inheritance. As shown in FIG. 9, if the neighbour left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

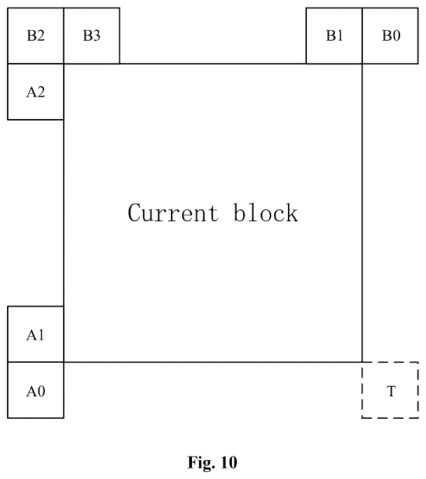

Constructed affine candidate means the candidate is constructed by combining the neighbor translational motion information of each control point. The motion information for the control points is derived from the specified spatial neighbors and temporal neighbor shown in FIG. 10. CPMVk(k=1, 2, 3, 4) represents the k-th control point. For CPMV1, the B2->B3->A2 blocks are checked and the MV of the first available block is used. For CPMV2, the B1->B0 blocks are checked and for CPMV3, the A1->A0 blocks are checked. For TMVP is used as CPMV4 if it's available.

After MVs of four control points are attained, affine merge candidates are constructed based on those motion information. The following combinations of control point MVs are used to construct in order:
{CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

FIG. 10 illustrates locations of Candidates position for constructed affine merge mode.

After inherited affine merge candidates and constructed affine merge candidate are checked, if the list is still not full, zero MVs are inserted to the end of the list.

### 2.2.2. Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AMVP candidate list size is 2 and it is generated by using the following four types of CPVM candidate in order:
Inherited affine AMVP candidates that extrapolated from the CPMVs of the neighbour CUs.
Constructed affine AMVP candidates CPMVPs that are derived using the translational MVs of the neighbour CUs.
Translational MVs from neighboring CUs.
Zero MVs.

The checking order of inherited affine AMVP candidates is same to the checking order of inherited affine merge candidates. The only difference is that, for AMVP candidate, only the affine CU that has the same reference picture as in current block is considered. No pruning process is applied when inserting an inherited affine motion predictor into the candidate list.

Constructed AMVP candidate is derived from the specified spatial neighbors shown in FIG. 10. The same checking order is used as done in affine merge candidate construction. In addition, reference picture index of the neighboring block is also checked. The first block in the checking order that is inter coded and has the same reference picture as in current CUs is used. There is only one When the current CU is coded with 4-parameter affine mode, and mv0 and mv1 are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.

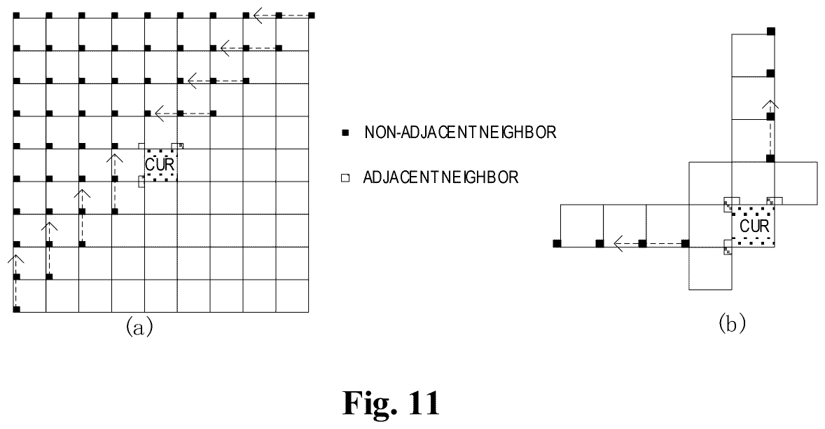

FIG. 11 illustrates spatial neighbors for deriving affine merge candidates: (a) for deriving inherited affine merge candidates (b) for deriving constructed affine merge candidates.

If affine AMVP list candidates is still less than 2 after valid inherited affine AMVP candidates and constructed AMVP candidate are inserted, mv0, mv1 and mv2 will be added, in order, as the translational MVs to predict all control point MVs of the current CU, when available. Finally, zero MVs are used to fill the affine AMVP list if it is still not full.

### 2.2.3. New Affine Candidates Derivation Methods in ECM-8.0

In ECM-6.0, 3 additional Affine merge and AMVP candidate derivation methods are integrated, which are non-adjacent spatial candidates, History-parameter-based candidates, Regression based affine candidates and Pixel based affine motion compensation.

### 2.2.3.1. Non-Adjacent Spatial Candidates

In ECM-6.0, non-adjacent spatial neighbors are investigated to provided candidates for both Affine merge and Affine AMVP. The pattern of obtaining non-adjacent spatial candidates is shown in FIG. 11. Same as the non-adjacent regular merge candidates, the distances between non-adjacent spatial candidates and current coding block are also defined based on the width and height of current CU.

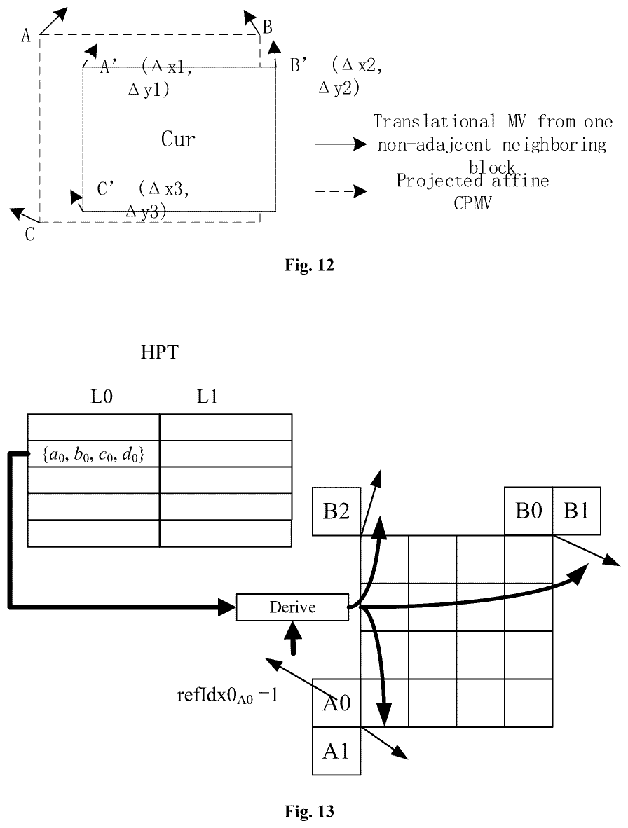

The motion information of the non-adjacent spatial neighbors in FIG. 11 is utilized to generate additional inherited and constructed affine merge candidates. Specifically, to generate inherited candidates, the non-adjacent spatial neighbors are checked based on their distances to the current block, i.e., from near to far. At a specific distance, only the first available neighbor which is coded with Affine mode from each side (e.g., the left and above) of the current block is included. As indicated in (a) of FIG. 11, the checking of the neighbors on the left and above sides are performed from bottom-to-up and right-to-left, respectively. For constructed candidates, as shown in (b) of FIG. 11, the positions of one left and above non-adjacent spatial neighbors are firstly determined independently; After that, the location of the top-left neighbor can be determined accordingly to form a rectangular virtual block together with the left and above non-adjacent neighbors. The motion information of the three non-adjacent neighbors is used to form the CPMVs at the top-left (A), top-right (B) and bottom-left (C) of the virtual block, which is projected to the current CU to generate the corresponding constructed candidates, as shown in FIG. 12.

### 2.2.3.2. History-Parameter-Based Affine Candidates

History-parameter-based affine model inheritance (HAMI) allows the affine model to be inherited from a previously affine-coded block which may not be neighboring to the current block. A history-parameter table (HPT) is established. An entry of HPT stores a set of affine parameters: a, b, c and d, each of which is represented by a 16-bit signed integer. Entries in HPT is categorized by reference list and reference index. Five reference indices are supported for each reference list in HPT. In a formular way, the category of HPT (denoted as HPTCat) is calculated as

$$HPTCat ( RefList , RefIdx ) = 5 \times RefList + min ( RefIdx , 4 ) \qquad ( 3 )$$

wherein RefList and Refldx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefListcur and Refldxcur, the affine parameters are utilized to update entries in the category HPTCat(RefListcur, Refldxcur) in a way similar to HMVP table updating.

A history-affine-parameter-based candidate (HAPC) is derived from a neighbouring 4×4 block denoted as A0, A1, B0, B1 or B2 in FIG. 13 and a set of affine parameters stored in a corresponding entry in HPT. The MV of a neighbouring 4×4 block served as the base MV. In a formulating way, the MV of the current block at position (x, y) is calculated as:

$$\{ \begin{matrix}{mv}^{h} ( x , y ) = a ( x - {x}_{base} ) + c ( y - {y}_{base} ) + {mv}_{base}^{h} \\ {mv}^{v} ( x , y ) = b ( x - {x}_{base} ) + d ( y - {y}_{base} ) + {mv}_{base}^{v}\end{matrix} , \qquad ( 4 )$$

where (mvhbase, mvvbase) represents the MV of the neighbouring 4×4 block, (xbase, ybase) represents the center position of the neighbouring 4×4 block. (x, y) can be the top-left, top-right and bottom-left corner of the current block to obtain the corner-position MVs (CPMVs) for the current block, or it can be the center of the current block to obtain a regular MV for the current block.

FIG. 13 shows an example of how to derive an HAPC from block AG. The affine parameters {a0, b0, c0, d0} are directly fetched from one entry of category HPTIdx(RefListA0, refldx0A0) in HPT. The affine parameters from HPT, with the center position of A0 as the base position, and the MV of block A0 as the base MV, are used together to derive the CPMVs for an affine merge HAPC, or an affine AMVP HAPC. They can also be used to derive MVs located at the center of the current block, as regular merge candidates. A HAPC can be put into the sub-block-based merge candidate list, the affine AMVP candidate list or the regular merge candidate list. As a response to new HAPCs being introduced, the size of sub-block-based merge candidate list is increased from five to ten and twelve for random access and low-delay B configurations, respectively. Besides, the size of regular merge candidate list is increased from ten to eleven for random access configurations to accommodate the newly added regular merge candidates.

FIG. 13 illustrates an example of generating an HAPC.

### 2.2.3.3. Regression Based Affine Candidate

In ECM-6.0, the regression based affine merge candidates are derived and added to the affine merge list. Subblock motion field from a previously coded affine CU and motion information from adjacent subblocks of a current CU are used as the input to the regression process to derive proposed affine candidates.

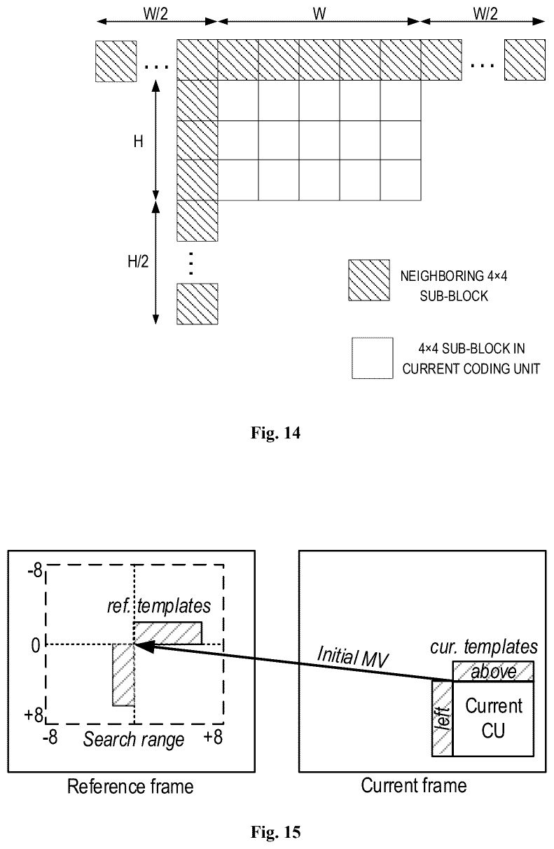

The previously coded affine CU can be identified from scanning through non-adjacent positions and the affine HMVP table. FIG. 14 illustrates an illustration of regression based affine merge candidate derivation. Adjacent subblock information of current CU is fetched from 4×4 sub-blocks represented by the grey zone as depicted in FIG. 14. For each sub-block, given a reference list, the corresponding motion vector and center coordinate of the sub-block may be used.

For each affine CU, up to 2 affine candidates can be derived. One with adjacent subblock information and one without. All the linear-regression-generated candidates are pruned and collected into one candidate sub-group, TM cost based ARMC process is applied when ARMC is enabled. Afterwards, up to N linear-regression-generated candidates are added to the affine merge list when N affine CUs are found.

### 2.2.3.4. Pixel Based Affine Motion Compensation

With pixel based affine motion compensation, minimum affine subblock size is set to lxi for luma component when OBMC is not applied, minimum subblock size is always set to lxi for chroma components.

### 2.3. Template Matching Merge/AMVP Mode in ECM

Template matching (TM) merge/AMVP mode is a decoder-side MV derivation method to refine the motion information of the current CU by finding the closest match between a template (i.e., top and/or left neighboring blocks of the current CU) in the current picture and a block (i.e., same size to the template) in a reference picture. FIG. 15 illustrates template matching performs on a search area around initial MV. As illustrated in FIG. 15, a better MV is to be searched around the initial motion of the current CU within a [−8, +8]-pel search range. In AMVP mode, an MVP candidate is determined based on the template matching error to pick up the one which reaches the minimum difference between the current block and the reference block templates, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode. This search process ensures that the MVP candidate still keeps the same MV precision as indicated by adaptive motion vector resolution (AMVR) mode after TM process.

In the merge mode, similar search method is applied to the merge candidate indicated by the merge index. TM merge may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check. When BM and TM are both enabled for a CU, the search process of TM stops at half-pel MVD precision and the resulted MVs are further refined by using the same model-based MVD derivation method as in DMVR.

### 2.4. Adaptive Reorder of Merge Candidates (ARMC)

Inspired by the spatial correlation between reconstructed neighboring pixels and the current coding block, adaptive reorder of merge candidates (ARMC) was proposed to refine the candidates order in a given candidate list. The underlying assumption is that the candidates with less template matching cost have higher probability to be chosen through RDO process, hence should be placed in front positions within the list to reduce the signaling cost.

The reordering method is applied to regular merge mode, template matching (TM) merge mode, and affine merge mode (excluding the SbTMVP candidate). For the TM merge mode, merge candidates are reordered before the refinement process.

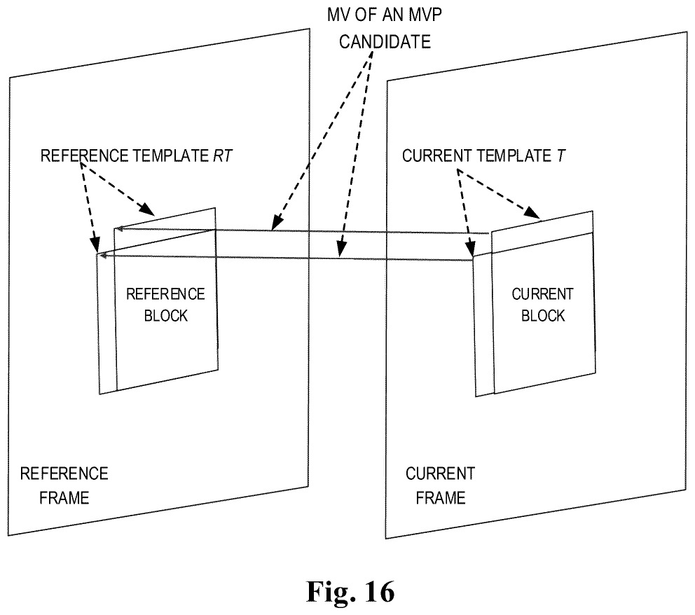

After a merge candidate list is constructed, merge candidates are divided into several subgroups. The subgroup size is set to 5. Merge candidates in each subgroup are reordered ascendingly according to cost values based on template matching. For simplification, merge candidates in the last but not the first subgroup are not reordered. The template matching cost is measured by the sum of absolute differences (SAD) between samples of a template of the current block and their corresponding reference template. FIG. 16 illustrates template and the corresponding reference template. The template comprises a set of reconstructed samples neighboring to the current block, while reference template is located by the same motion information of the current block, as illustrated in FIG. 16. When a merge candidate utilizes bi-directional prediction, the reference samples of the template of the merge candidate are also generated by bi-prediction.

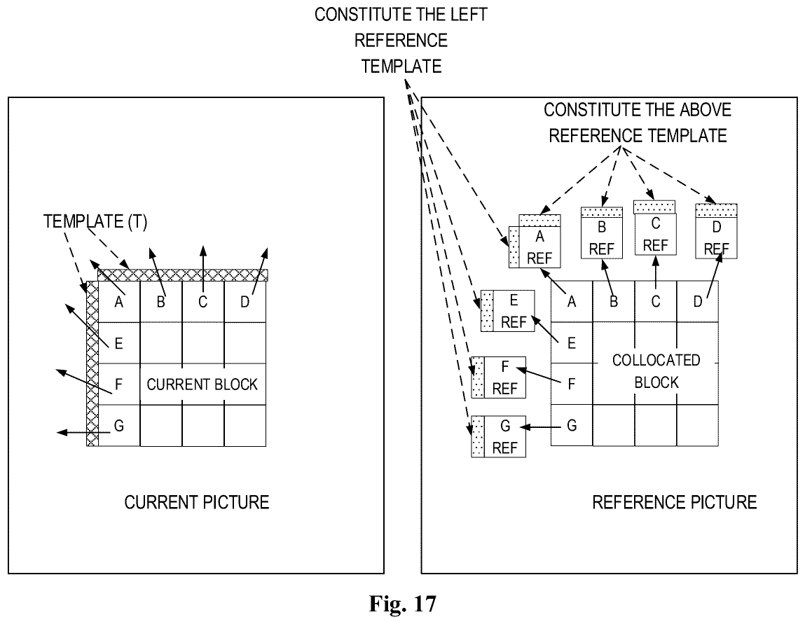

For subblock-based merge candidates with subblock size equal to Wsub*Hsub, the above template comprises several sub-templates with the size of Wsub×K, and the left template comprises several sub-templates with the size of K×Hsub. FIG. 17 illustrates template and reference template for block with sub-block motion using the motion information of the subblocks of current block. As shown in FIG. 17, the motion information of the subblocks in the first row and the first column of current block is used to derive the reference samples of each sub-template.

### 2.5. Subblock-Based Temporal Motion Vector Prediction (SbTMVP)

VVC supports the subblock-based temporal motion vector prediction (SbTMVP) method. Similar to the TMVP, SbTMVP takes advantage of the motion field in the collocated picture to facilitate more precise MVP derivation. The same collocated picture used by TMVP is used for SbTMVP. SbTMVP differs from TMVP mainly in two aspects. Firstly, SbTMVP enables sub-CU level motion prediction whereas TMVP predicts motion at CU level; Secondly, compared with TMVP that fetches the temporal MV from the collocated block in the collocated picture (the collocated block is the bottom-right or center block relative to the current CU), SbTMVP applies a motion shift before fetching the temporal motion information from the collocated picture, where the motion shift is obtained by re-using the MV from one of the spatial neighboring blocks of the current CU.

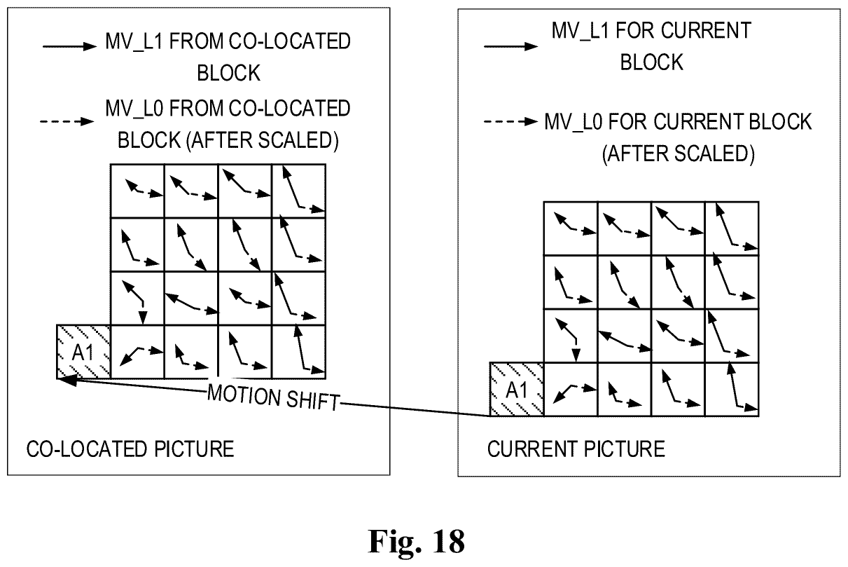

FIG. 18 illustrates the derivation process of the sub-block level motion field for SbTMVP. In particular, the motion information of left-bottom sub-block A1 is firstly fetched, if either of the MVs in reference list0 and list1 points to the collocated frame, then the corresponding MV will be identified as motion shift. Otherwise, zero my will be used as motion shift.

Once the motion shift is determined, the specified region in the collocated frame is employed to derive sub-block level motion field. Assuming A1′ motion is used as motion shift as depicted in FIG. 18. Then for each sub-CU, the motion information of its corresponding block (the smallest motion grid that covers the center sample) in the collocated picture is fetched to provide motion information, where MV scale operation is firstly performed to align the reference frames of the temporal motion vectors to those of the current CU.

In VVC and ECM, in addition to CU level MVP candidate list, a sub-CU level MVP candidate list is also constructed to provide more precise motion prediction for the current CU, which comprises the motion fields produced by both SbTMVP and AFFINE methods. In particular, only one SbTMVP candidate is included and is always placed in the first entry of the constructed sub-CU level MVP candidate list, whereas multiple AFFINE candidates are included in the list after performing template matching-based reordering, where those with smaller costs are placed in fronter positions.

### 2.6. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.6.1 Simplification of IBC Vector Prediction

The BV predictors for merge mode and AMVP mode in IBC will share a common predictor list, which consist of the following elements:
2 spatial neighboring positions (A0, B0 as in FIG. 1).
5 HMVP entries.
Zero vectors by default.

For merge mode, up to first 6 entries of this list will be used; for AMVP mode, the first 2 entries of this list will be used. And the list conforms with the shared merge list region requirement (shared the same list within the SMR).

### 2.6.2 IBC Reference Region

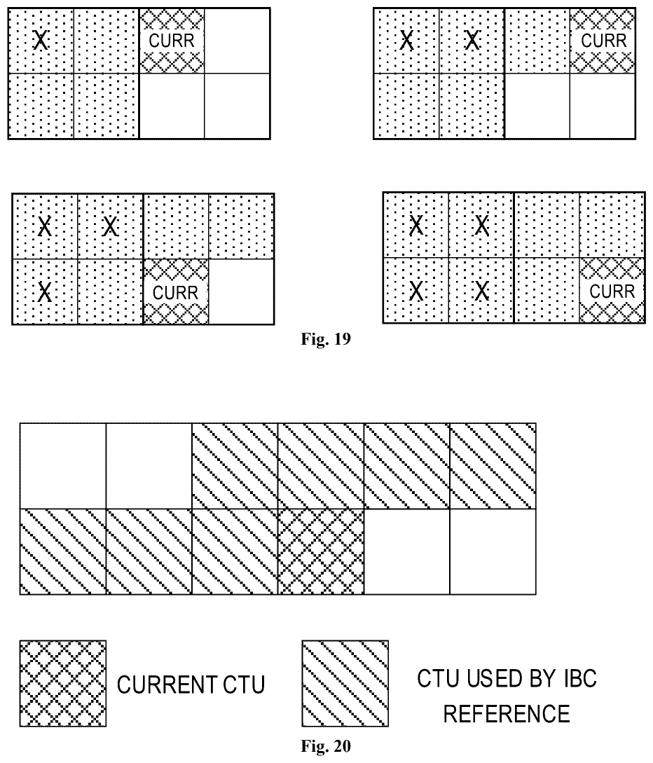

To reduce memory consumption and decoder complexity, the IBC in VVC allows only the reconstructed portion of the predefined area including the region of current CTU and some region of the left CTU. FIG. 19 illustrates current CTU processing order and its available reference samples in current and left CTU. FIG. 19 illustrates the reference region of IBC Mode, where each block represents 64×64 luma sample unit.

Depending on the location of the current coding CU location within the current CTU, the following applies:
If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU, it can only refer to the already reconstructed samples in the current CTU, using CPR mode.

This restriction allows the IBC mode to be implemented using local on-chip memory for hardware implementations.

2.6.3 IBC Interaction with Other Coding Tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitstream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hlbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min(ctbSize, 64) in each dimension, Wv=min(ctbSize, 64).

The virtual IBC buffer, ibcBuf is maintained as follows.
At the beginning of decoding each CTU row, refresh the whole ibcBuf with an invalid value −1.
At the beginning of decoding a VPDU (xVPDU, yVPDU) relative to the top-left corner of the picture, set the ibcBuf[x][y]=−1, with x=xVPDU % wlbcBuf, . . . , xVPDU % wlbcBuf+Wv−1; y=yVPDU % ctbSize, . . . , yVPDU % ctbSize+Wv−1.
After decoding a CU contains (x, y) relative to the top-left corner of the picture, set:

$$ibcBuf [ x \% wIbcBuf ] [ y \% ctbSize ] = recSample [ x ] [ y ] .$$

For a block covering the coordinates (x, y), if the following is true for a block vector bv=(bv[0], bv[1]), then it is valid; otherwise, it is not valid:
ibcBuf[(x+bv[0])% wlbcBuf][(y+bv[1]) % ctbSize] shall not be equal to −1.

### 2.6.4 IBC Virtual Buffer Test

A luma block vector bvL (the luma block vector in 1/16 fractional-sample accuracy) shall obey the following constraints:

- CtbSizeY is greater than or equal to ( ( yCb + ( bvL[ 1 ] >> 4 ) ) & ( CtbSizeY − 1 ) ) + cbHeight.
- IbcVirBuf[ 0 ][ ( x + (bvL[ 0 ] >> 4 ) ) & ( IbcBufWidthY − 1 ) ][ ( y + (bvL[ 1 ] >> 4 ) ) & ( CtbSizeY
− 1 ) ] shall not be equal to −1 for x = xCb..xCb + cbWidth − 1 and y = yCb..yCb + cbHeight − 1.

Otherwise, bvL is considered as an invalid bv.

The samples are processed in units of CTBs. The array size for each luma CTB in both width and height is CtbSizeY in units of samples.
(xCb, yCb) is a luma location of the top-left sample of the current luma coding block relative to the top-left luma sample of the current picture,
cbWidth specifies the width of the current coding block in luma samples,
cbHeight specifies the height of the current coding block in luma samples.
   2.6.5 IBC with Exteded Reference Area

An IBC reference area design is proposed that does not increase the current memory area required by ECM-3 and tests the performance.

FIG. 20 illustrates the design. FIG. 20 illustrates an illustration of the extended reference area. In FIG. 20, the square filled with crosshatch denotes the current CTU and the squares filled with diagonal line denote CTUs that may be used by IBC reference. Specifically, assume that W denotes the maximum horizontal CTU index and the current CTU index is (m, n), for coding units in the current CTU, CTUs with index (0, n) . . . (in, n) and (m−1, n) . . . (W, n) defines the reference area that can be used by IBC.

One reason to have such a design is that in the current ECM, the left, above and upper-left CTUs are being used and thus need to be saved. To achieve this, all CTUs to the right of the above CTU in the above CTU row (for CTUs to be coded in the current CTU row) and all CTUs to the left of the current CTU in the current CTU row (for CTUs to be coded in the next CTU row) must be kept. It means that such a design does not increase the buffer size required by the current ECM.

2.6.6 IBC with Template Matching

It is proposed to also use Template Matching with IBC for both IBC merge mode and IBC AMVP mode. The IBC-TM merge list has been modified compared to the one used by regular IBC merge mode such that the candidates are selected according to a pruning method with a motion distance between the candidates as in the regular TM merge mode. The ending zero motion fulfillment (which is a nonsense regarding Intra coding) has been replaced by motion vectors to the left (−W, 0), top (0, −H) and top-left (−W, −H) CUs, then, if necessary, the list is fulfilled with the left one without pruning.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC merge list. Each of those 3 selected candidates are refined using the Template Matching method and sorted according to their resulting Template Matching cost. Only the 2 first ones are then considered in the motion estimation process as usual.

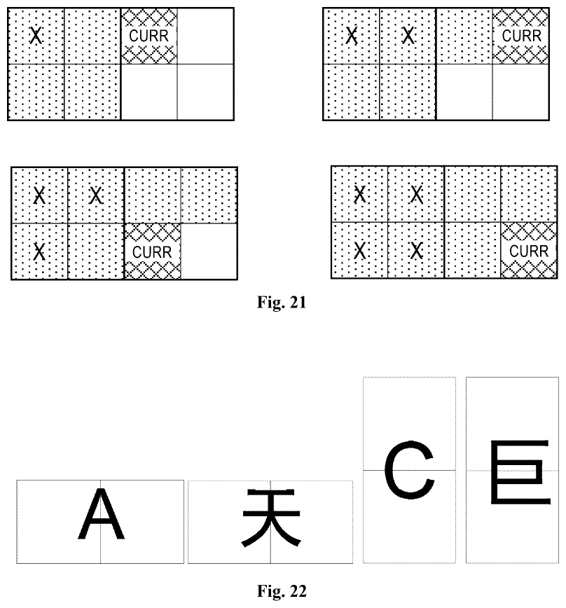

FIG. 21 illustrates an example IBC reference region depending on current CU position. The Template Matching refinement for both IBC-TM merge and AMVP modes is quite simple since IBC motion vectors are constrained to be integer and within a reference region as shown in FIG. 21. So, in IBC-TM merge mode, all refinements are performed at integer precision, and in IBC-TM AMVP mode, they are performed either at integer or 4-pel precision. In both cases, the refined motion vectors in each refinement step must respect the constraint of the reference region.

### 2.6.7 Reconstruction-Reordered IBC

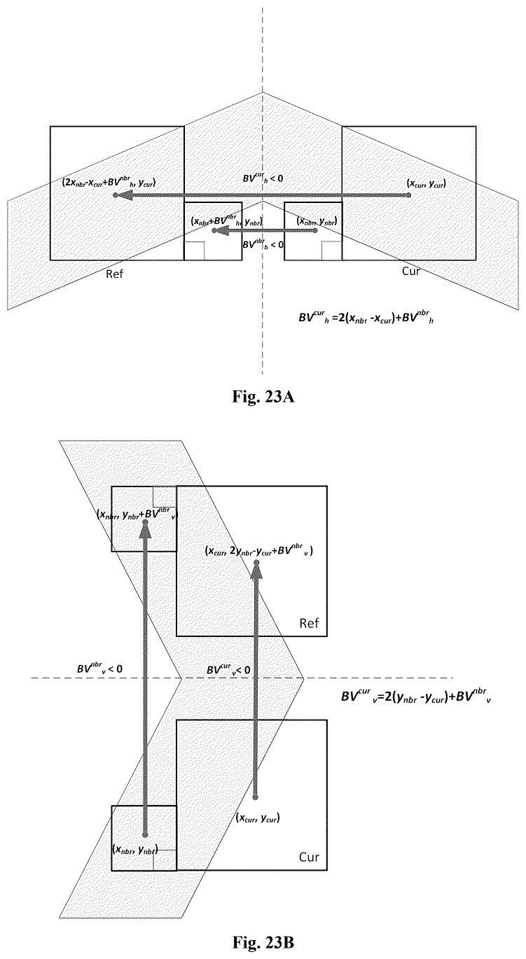

FIG. 22 illustrates examples of symmetry in screen content pictures.

Screen content coding tools like Intra Block Copy (IBC) generate a prediction block by directly copying a prior coded reference region in the same picture. Symmetry is often observed in video content, especially in text character regions and computer-generated graphics in screen content sequences, as shown in FIG. 19. Therefore, a specific screen content coding tool considering the symmetry would be efficient to compress such kinds of video contents.

A Reconstruction-Reordered IBC (RR-IBC) mode is proposed for screen content video coding. When it is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied. To better utilize the symmetry property, a flip-aware BV adjustment approach is applied to refine the block vector candidate. FIG. 23A illustrates an illustration of BV adjustment for horizontal flip. FIG. 23B illustrates an illustration of BV adjustment for vertical flip. For example, as shown in FIG. 23A and FIG. 23B, (xnbr, ynbr) and (xcur, ycur) represent the coordinates of the center sample of the neighboring block and the current block, respectively, BVnbr and BVcur denotes the BV of the neighboring block and the current block, respectively. Instead of directly inheriting the BV from a neighbouring block, the horizontal component of BVcur is calculated by adding a motion shift to the horizontal component of BVnbr (denoted as BVnbrh) in case that the neighbouring block is coded with a horizontal flip, i.e., BVcurh=2(xnbr−xcur)+BVnbrh. Similarly, the vertical component of BVcur is calculated by adding a motion shift to the vertical component of BVnbr (denoted as BVnbrv) in case that the neighbouring block is coded with a vertical flip, i.e., BVcurv=2(ynbr−ycur)+BVnbrv.

### 3. Problems

The existing IBC prediction is generated with only one predictor, which may be further improved with bi-predictive or multi-hypothesis strategy.

### 4. Detail Solutions

In this disclosure, it is proposed to further improve IBC motion compensation by incorporating MV and multiple BV predictors, thus IBC can benefit from multi-hypothesis prediction.

The detailed embodiments below should be considered as examples to explain general concepts. These embodiments should not be interpreted in a narrow way. Furthermore, these embodiments can be combined in any manner.

The term ‘BV predictor’ may represent a BV to derive the prediction samples; ‘MV predictor’ may represent a MV to derive the prediction samples. The term ‘BVP list’ may represent a group of BVPs that may be used to provide the BVP for regular IBC/IBC MMVD/IBC TM mode/IBC-GPM/IBC-LIC/IBC-CIIP/IBC-AMVP/TM based IBC-AMVP/IBC-MBVD/RR-IBC/filter-based IBC/bi-predictive IBC/IBC blending/multi-hypoth modes. The terms ‘video unit’ or ‘coding unit’ or ‘block’ may represent a coding tree block (CTB), a coding tree unit (CTU), a coding block (CB), a CU, a PU, a TU, a PB, a TB.

In this disclosure, regarding “a block coded with mode N”, here “mode N” may be a prediction mode (e.g., MODE_INTRA, MODE_INTER, MODE_PLT, MODE_IBC, and etc.), or a coding technique (e.g., DIMD, TIMD, PDPC, CCLM, CCCM, GLM, intraTMP, AMVP, SMVD, Merge, BDOF, PROF, DMVR, ADMVR, bilateral matching AMVP-merge, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, OBMC, ALF, deblocking, SAO, bilateral filter, LMCS, IBC merge, IBC AMVP, IBC-TM merge, IBC-TM AMVP, IBC-MBVD, RR-IBC and the corresponding variants, and etc.).

It is noted that the terminologies mentioned below are not limited to the specific ones defined in existing standards. Any variance of the coding tool is also applicable.

1. K (K>1) candidate block vectors (BVs) may be used to generate a final prediction sample,
a) K (K>1) candidate block vectors (BVs) may be used to generate a final prediction sample in bi-predictive IBC or multi-hypothesis IBC mode.
b) In one example, an involved BV yields a prediction sample, and/or a final prediction sample is generated by blending at least two prediction samples derived by BVs. An involved BV is denoted as a “BV predictor”.
c) In one example, the BV prediction (BVP) and/or BVP list used for a specific coding tool may be directly re-used to derive a BVP and/or BVP list that is used to generate a final prediction sample.
   i. In one example, the coding tool may refer to regular IBC/IBC MMVD/IBC TM mode/IBC-GPM/IBC-LIC/IBC-CIIP/IBC-AMVP/TM based IBC-AMVP/IBC-MBVD/RR-IBC/filter-based IBC.
   ii. In one example, alternatively, a different BVP or BVP list compared to the specific coding tool is constructed.
d) In one example, at least one BV predictor may be derived from a BVP list.
   i. In one example, an index of a BVP in a BVP list may be signaled to specify the BV predictor.
      1) In one example, a BVP index may be independently coded.
      2) In one example, the derivation of a BVP index may be dependent on another BVP index.
         a) In one example, specifically, the index of a BVP may be used as the prediction of another index, and/or the difference of two indices may be signalled or parsed.
   ii. In one example, the candidates in BVP list may be firstly reordered based on certain metric, e.g., template matching cost.
   iii. In one example, no index is signaled to specify BVP.
      1) In one example, the top N candidate(s) with the least N or highest N cost (s) are used as the predictors to generate a blending prediction sample,
         a) In one example, N>1.
         b) In one example, N=2.
   iv. In one example, at least one index may be signalled, while at least one index may be adaptively derived.
e) In one example, at least one BV predictor may be generated with a candidate (e.g., an IBC-AMVP candidate) plus block vector difference (BVD) or a candidate (e.g., an IBC-MBVD candidate) plus the BVD indicated by MBVD index.
   i. In one example, for at least one BV predictor, the BV prediction (BVP) in a BVP list is directly used to generate the BV predictor. While for at least one BV predictor, the BVD or BVD indicated by MBVD index may be added with BVP to generate the BV predictor.
   ii. In one example, which BV predictor needs BVD or MBVD index may be signalled in the bitstream, e.g., DPS/SPS/VPS/PPS/APS/picture header/slice header/tile group header.
      1) In one example, which BV predictor needs BVD or MBVD may be specified by both encoder and decoder, such that no syntax is need in the bitstream.
   iii. In one example, MBVD index or BVD is signalled for all the BVPs or BV predictors of a block.
      1) In one example, no syntax is used to indicate the BVD precision, and a fixed precision is used by both encoder and decoder, by default.
         a) Alternatively, the ABVR/AMVR index is used to express the BVD precision.
      2) In one example, a syntax is signalled to express the BVD precision.
   iv. In one example, alternatively, the BVP is directly used to generate prediction samples for all the predictors.
f) In one example, a universal BVP list may be built for all the BV predictors.
   i. In one example, at least two different BVP lists may be built for at least two different BV predictors.
g) In one example, the prediction sample(s) of at least one regular BV predictor may be blended with the prediction sample(s) of at least one RR-IBC predictor.
h) In one example, at least one BV predictor may firstly be refined by template matching, then the refined BV predictor is used to get prediction sample.
i) In on example, all the K (e.g., K=2) BVs are stored for a block coded with bi-predictive IBC or multi-hypothesis IBC.

2. A first prediction sample generated by at least one involved BV and a second prediction sample generated by at least one involved motion vector (MV) may be used to generate a final prediction sample. An involved MV is denoted as a “MV predictor”.
a) In one example, first prediction sample and the second prediction sample may be blended to generate a final prediction sample.
b) In one example, a first prediction sample generated by an involved BV and a second prediction sample generated by an involved MV may be used to generate a final prediction sample in IBC blending mode.
c) In one example, a MV predictor may comprises MVP index, and/or MVD, and/or MMVD index, and/or reference index, and/or reference list index, etc.
d) In one example, both BV and MV may be stored for a block coded with IBC blending mode.
e) In one example, the BVP in the BVP list may be directly used to generate BV predictor.
   i. In one example, alternatively, a BV may be constructed by adding BVP and BVD, which is then used as BV predictor.
      1) In one example, the BVD may be expressed by directly signalling the horizontal/vertical components of the BVD or be expressed by a MBVD index.
f) In one example, the method described in bullet 1 can be used to get BV predictor.
g) In one example, MVP list may be constructed by re-using or reforming the MVP list of a specific coding tool.
   i. In one example, a specific coding tool may refer to regular merge/TM merge/BM merge/AMVP-merge/ADMVR/regular AMVP/TM-AMVP.
   ii. In one example, the MVP list of a specific coding tool may be directly re-used to derive MV predictor.
   iii. In one example, the candidates in regular merge/TM merge/BM merge/AMVP-merge/ADMVR/regular AMVP/TM-AMVP candidate list may be checked in order, which will be included in the current MVP list if satisfies certain conditions.
   iv. In one example, only uni-directional MVP candidate can be included in the list.
      1) In one example, alternatively, both uni- and bi-directional candidates can be included in the list.
   v. In one example, a regular merge/TM merge/BM merge/AMVP-merge/ADMVR/regular AMVP/TM-AMVP MVP list may firstly be reordered based on certain metric, e.g., template matching cost, then the top M candidate(s) with the least M or highest M cost(s) may be used to construct the MVP list for IBC bi-prediction or IBC blending mode.
      1) In one example, M>1.
   vi. In one example, a different MVP list may be constructed to provide the MV predictors for IBC bi-prediction or IBC blending mode.
h) In one example, MVP index may be signalled to generate a MV predictor.
   i. In one example, alternatively, the MVP list may be reordered based on certain metric, e.g., template matching cost, then the top P candidate(s) with the least P or highest P cost(s) are used to generate MV predictor.
      1) In one example, P>1.
i) In one example, MVD or MMVD index may be used to generate a MV predictor.
   i. In one example, no syntax is used to indicate the MVD precision, and a fixed precision is used by both encoder and decoder, by default.
      1) In one example, alternatively, the AMVR index is used to express the MVD precision.
   ii. In one example, a syntax is signalled to express the MVD precision.

3. A first prediction sample generated by at least one involved BV and a second prediction sample generated by at least one intra prediction method may be used to generate a prediction sample,
a) In one example, the intra prediction sample may refer to conventional intra prediction, DIMD, TIMD, MRL, ISP, MIP, IntraTMP, intra prediction fusion, SGPM, TMRL, PDPC/gradient PDPC, CCLM, MMLM, CCCM, GLM, chroma fusion, or their variants.

4. A BVP list may be constructed with bi-predictive BVPs.
a) In one example, a bi-predictive BVP contains M (M>1, e.g., M=2) BVs.
   i. In one example, the M BVs of a bi-predictive BVP may be the same.
   ii. In one example, the M BVs of a bi-predictive BVP may be different.
b) In one example, a bi-predictive BVP may comprise both BV and motion information.
   i. In one example, the motion information may be MV/reference index/reference list index.
   ii. In one example, only MV is need for motion information, and a fixed/derived reference frame, i.e., with constant/derived reference index and/or reference list index, is used.
c) In one example, if the BVP specified by a BVP index is bi-predictive, then the block would be coded with bi-predictive IBC or IBC blending mode.
   i. Alternatively, if the BVP specified by a BVP index is uni-predictive, then the block would be coded with uni-predictive IBC.
d) In one example, a bi-predictive BVP may be collected from adjacent spatial/non-adjacent spatial/adjacent temporal/non-adjacent temporal positions or a table that stores history BVPs or MVPs.
e) In one example, A BVP list may be constructed with only bi-predictive candidates.
   i. In one example, alternatively, a BVP list may be constructed with only uni-predictive BVP candidates.
   ii. In one example, alternatively, a BVP list may be constructed with both uni-predictive and bi-predictive BVP candidates.
   iii. In one example, multiple BVP lists may be constructed, some of them are constructed with only uni-predictive BVPs, and/or some of them are constructed with both uni-predictive and bi-predictive BVP candidates, and/or some are constructed with only bi-predictive BVPs.
f) In one example, a hybrid list which comprises both MVP and/or BVP may be constructed.

5. A BVP list may be constructed with at least one uni-predictive and at least one bi-predictive BVPs.
a) In one example, the number of the candidates in BVP list may not exceed a certain constant or a derived value.
   i. In one example, the number of uni-predictive candidate in the list may not exceed a certain constant or a derived value.
   ii. In one example, the number of bi-predictive candidate in the list may not exceed a certain constant or a derived value.
b) In one example, the BVP list which comprises at least one uni-predictive and at least one bi-predictive BVPs may be built by traversing the BVP candidates in a predefined order.
   i. In one example, the BVP candidates may be:
      1) adjacent neighboring BVPs;
      2) adjacent neighboring BVPs at specific location(s);
      3) TMVP BVPs;
      4) HMVP BVPs;
      5) Non-adjacent spatial/temporal BVPs;
      6) Constructed BVPs (such as pairwise BVPs).
   ii. In one example, a BVP may be included in the list no matter if it is bi- or uni-predictive.
c) In one example, a bi-predictive BVP and a uni-predictive BVP may be assigned with different priority to be included in the list.
   i. In one example, a bi-predictive BVP may have higher (or lower) priority to be included in the list.
   ii. In one example, a bi-predictive (or uni-predictive) BVP may be included in the list after a uni-predictive (or bi-predictive).
   iii. In one example, a bi-predictive (or uni-predictive) BVP may be included in the list only if the number of all available uni-predictive (or bi-predictive) doesn't reach a constant or an adaptively derived value.
d) In one example, the BVP list which comprises at least one uni-predictive and at least one bi-predictive BVPs may be reordered based on certain metrics, e.g., template matching cost.
   i. In one example, for a uni-predictive BVP candidate, the reference template may be generated with uni-prediction.
   ii. In one example, for a bi-predictive BVP candidate, the reference template may be generated with bi- or uni-prediction.
   iii. In one example, the TM cost of a bi-predictive (or uni-predictive) BVP candidate may be further adjusted before sorting with uni-predictive (or bi-predictive) BVPs.
      1) In one example, the TM cost may be adjusted by applying a linear or non-linear transform to the initial TM cost.

6. A BVP list may be constructed along with pruning operation.
a) In one example, a uni-predictive (or bi-predictive) BVP may be directly included in a BVP list without pruning operation if all the BVPs in the list are bi-predictive (or uni-predictive).
b) In one example, a uni-predictive BVP candidate may be included in a BVP list only if it is different from each (or some) of the uni-predictive BVP(s) that is (are) already in the list.
   i. In one example, alternatively, a bi-predictive BVP candidate may be included in a BVP list only if it is different from each (or some) of the bi-predictive BVP(s) that is (are) already in the list.
   ii. In one example, two BVPs may be determined to be different only if the absolute difference of at least one component of at least one BV is larger than a constant or an adaptively determined value.
      1) In one example, alternatively, two BVPs may be determined to be different only if the absolute difference of each component of each BVs is larger than a constant or an adaptively determined value.
      2) In one example, the threshold may be 0.
      3) In one example, the threshold may be an arbitrary value larger than 0.

7. The prediction samples of BV and/or MV predictors may be blended as a weighted sum to generate a final prediction.
a) In one example, the weighting value may be equal for two prediction samples generated by BV predictors or MV predictors.
b) In one example, multiple weighting values may be predefined, and/or applied weighting value may be derived at decoder.
   i. In one example, the weighting value may be derived based on at least a cost value.
      1) The cost may be the SAD between reconstruction samples and prediction samples on a template of the current block.
   ii. In one example, applied weighting value may be derived by a signalled index at decoder.
c) In one example, the prediction samples of one or more predictors may firstly conduct LIC and/or OBMC before generating the final prediction.
   i. In one example, for each predictor, no LIC or OBMC is conducted to the prediction samples.
d) In on example, the prediction samples of one or more predictors may first conduct filtering operation before generating the final prediction.
   i. In one example, a fix-shape filter of which the coefficients may be derived using the current template and reference template (or the reconstructed template and predicted template) is used to refine the corresponding prediction samples, which is then used to generate the final prediction.
e) In one example, a constant weight is used to blend the prediction samples of multiple predictors.
   i. In one example, a weight index may be signaled to specify a candidate in a set of weights.
      1) In one example, the available weights in the set may be signalled in the DPS/SPS/VPS/PPS/APS/picture header/slice header/tile group header.
         a) Alternatively, the available weights in the set may be predefined in both encoder and decoder.
      2) In one example, a same weight set may be used by both encoder and decoder, such that no weight index is needed.
   ii. In one example, the weight to blend multiple prediction samples may be adaptively derived with a template.
      1) In one example, prediction of a template region (e.g., adjacent left and/or upper regions) of a block may be generated with the same MV or BV, and an optimal weight is derived by using the reconstruction and the prediction samples of template region.
         a) In one example, the derived weight may be rounded to a fixed value before used to blend the prediction.
   iii. In one example, the blending weight in one position may be different from that of another position.
f) In one example, the weights used to blend the prediction samples may be derived.
   i. In one example, the weights may be derived using the neighboring samples.
      1) In one example, the LDL or Gaussian elimination used in CCCM may be used.
      2) In one example, the Least-Mean-Square (LMS) method may be used.
      3) In one example, an method derives the weights or parameters used in another coding tool may be re-used, such as CCCM, LIC, CCLM.

8. In one example, both BVD (or MBVD index) and MVD (or MMVD index) may be signaled for a coding block.

9. In one example, a first syntax indicating whether to use bi-predictive IBC or IBC blending may be signaled, if this syntax is true (or false), then a second syntax indicating whether BV or MV is used to generate the second predictor is signaled.

10. Whether the proposed method is used may be dependent on the content characteristics, e.g., screen contents or nature contents.

11. The disclosed methods above may apply to other coding tools, such as IntraTMP.

### General Aspects

12. In above examples, the video unit may refer to the video unit may refer to colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block(PB)/transform block (TB)/a block/sub-block of a block/sub-region within a block/any other region that contains more than one sample or pixel.

13. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.

14. Whether and/or how to apply the above methods may depend on the following information:
a) A message signalled in the DPS/SPS/VPS/PPS/APS/picture header/slice header/tile group header/Largest coding unit (LCU)/Coding unit (CU)/LCU row/group of LCUs/TU/PU block/Video coding unit.
b) Position of CU/PU/TU/block/Video coding unit.
c) Block dimension of current block and/or its neighbouring blocks.
d) Block shape of current block and/or its neighbouring blocks.
e) coded mode of a block, e.g., IBC or non-IBC inter mode or non-IBC subblock mode.
f) Indication of the colour format (such as 4:2:0, 4:4:4).
g) Coding tree structure.
h) Slice/tile group type and/or picture type.
i) Colour component (e.g., may be only applied on chroma components or luma component).
j) Temporal layer ID.
k) Profiles/Levels/Tiers of a standard.

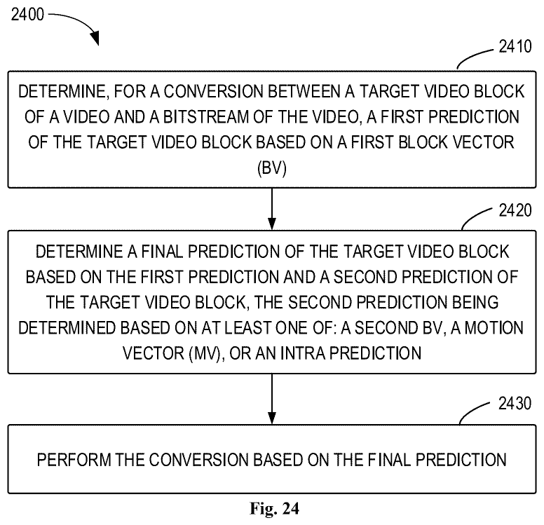

FIG. 24 illustrates a flowchart of a method 2400 for video processing in accordance with embodiments of the present disclosure. The method 2400 is implemented for a conversion between a video block or a video unit of a video and a bitstream of the video.

At block 2410, for a conversion between a target video block of a video and a bitstream of the video, a first prediction of the target video block is determined based on a first block vector (BV). As used herein, the term “target video unit” refers to a video block or a video unit to be processed, which may also be referred to as a “current video block”.

At block 2420, a final prediction of the target video block is determined based on the first prediction and a second prediction of the target video block. The second prediction is determined based on at least one of: a second BV, a motion vector (MV), or an intra prediction. It is to be understood that the final prediction may be determined based on more than two predictions in some embodiments. For example, K predictions (K being an integer greater than 1) may be used to determine the final prediction.

K predictions may include a first prediction from a first BV, and at least one second prediction from at least one of: at least one BV, at least one MV or at least one intra prediction. The prediction from BV, the prediction from MV and/or the intra prediction may be blended in any suitable manner. Scope of the present disclosure is not limited here.

At block 2430, the conversion is performed based on the final prediction. In some embodiments, the conversion includes encoding the target video block into the bitstream. Alternatively, or in addition, in some embodiments, the conversion includes decoding the target video block from the bitstream.

The method 2400 enables determining the final prediction based on a BV and a further BV or MV or intra prediction. In this way, the coding effectiveness and coding efficiency can be improved.

In some embodiments, the final prediction is in a bi-predictive intra block copy (IBC) mode or a multi-hypothesis IBC mode.

In some embodiments, the final prediction is determined based on blending the first and second predictions.

In some embodiments, the final prediction is determined based on a block vector prediction (BVP) or a BVP list, wherein the BVP or the BVP list is determined based on re-using a further BVP or a further BVP list of a first coding tool.

In some embodiments, the first coding tool comprises at least one of: an intra block copy (IBC), an IBC merge mode with motion vector difference (MMVD), an IBC template matching (TM) mode, an IBC with geometric partitioning mode (GPM) (IBC-GPM), an IBC with local illumination compensation (LIC) (IBC-LIC), an IBC-combined intra and inter prediction mode (CIIP) (IBC-CIIP), an IBC-advanced motion vector prediction (AMVP), a TM based IBC-AMVP, an IBC merge mode with block vector difference (MBVD), a reconstruction-reordered IBC (RR-IBC), or a filter-based IBC.

In some embodiments, the BVP or BVP list is different from the further BVP or further BVP list used for the first coding tool.

In some embodiments, at least one of the first or second BV is determined based on a BV prediction (BVP) list.

In some embodiments, an index of a candidate BVP of the BVP list in the bitstream indicates the first BV.

In some embodiments, the index is independently coded.

In some embodiments, the index is determined based on another index of another BVP of the BVP list.

In some embodiments, the index is used as a prediction of the other index, and/or a difference of the index and the other index is included in the bitstream or parsed.

In some embodiments, candidate BVPs of the BVP list is ordered based on a first metric comprising a template matching cost.

In some embodiments, no index of candidate BVP in the BVP list is included in the bitstream, and top N candidate BVPs of the BVP list with the least N or highest N costs are used in determining the final prediction, wherein N is a positive integer.

In some embodiments, N is larger than or equal to 2.

In some embodiments, at least one index of at least one BVP in the BVP list is included in the bitstream, or at least one index of at least one BVP in the BVP list is adaptively derived.

In some embodiments, at least one BV predictor for the target video block is determined based on a first candidate added with a first block vector difference (BVD) or a second candidate added with a second BVD indicated by a BVD index.

In some embodiments, the first candidate comprises an intra block copy-advanced motion vector prediction (IBC-AMVP) candidate, the second candidate comprises an IBC merge mode with block vector difference (IBC-MBVD) candidate, and the BVD index comprises a MBVD index.

In some embodiments, at least one BV predictor for the target video block is determined based on a second block vector difference (BVD) indicated by a BVD index added with a candidate ABVP of the BVP list.

In some embodiments, the at least one BV predictor for the target video block is included in one of a dependency parameter set (DPS), a sequence parameter set (SPS), a video parameter set (VPS), a picture parameter set (PPS), an adaptation parameter sets (APS), a picture header, a slice header, or a tile group header in the bitstream.

In some embodiments, the at least one BV predictor for the target video block is specified by an encoder and a decoder for the conversion.

In some embodiments, at least one of the BVD index, the first BVD or the second BVD is indicated for all of the BVPs or the first BV of the target video block.

In some embodiments, no syntax is used to indicate a precision of the first and second BVDs, and wherein a fixed precision is used by an encoder and a decoder to indicate the precision of the first and second BVDs.

In some embodiments, the fixed precision comprises an adaptive block vector resolution (ABVR) index or an adaptive motion vector resolution (AMVR) index.

In some embodiments, a syntax in the bitstream indicates a precision of the first and second BVDs.

In some embodiments, the BVP in the BVP list is used to generate prediction samples for BV predictors.

In some embodiments, a universal BVP list is determined for a plurality of BV predictors.

In some embodiments, the method 2400 further comprises: determining at least two different BVP lists for at least two different BV predictors.

In some embodiments, prediction samples of at least one BVP are blended with prediction samples of at least one reconstructed reordered intra block copy (RR-IBC) predictor.

In some embodiments, at least one BV predictor is refined by template matching, and a prediction sample of the target video block is determined based on the at least one refined BV predictor.

In some embodiments, at least the first and second BVs are stored for the target video block coded with bi-predictive intra block copy (IBC) or multi-hypothesis IBC.

In some embodiments, the final prediction is determined based on the first prediction based on the first BV and the second prediction based on the MV in an intra block copy (IBC) blending mode.

In some embodiments, the second prediction is determined further based on at least one of: a motion vector prediction (MVP) index, a motion vector difference (MVD), a merge mode with MVD (MMVD) index, a reference index, or a reference list index.

In some embodiments, the first BV and the MV are stored for the target video block coded with IBC blending.

In some embodiments, the first BV is determined based on a BVP of a BVP list.

In some embodiments, the first BV is determined based on adding the BVP and a BVD.

In some embodiments, the BVD is expressed by including at least one of a horizontal component of the BVD, a vertical component of the BVD or a merge mode with BVD (MBVD) index in the bitstream.

In some embodiments, the first BV is determined based on a BV predictor of the target video block.

In some embodiments, the method 2400 further comprises: determining a motion vector prediction (MVP) list based on re-using or reforming a further MVP list of a second coding tool.

In some embodiments, the second coding tool comprises: a merge, a template matching (TM) merge, a bilateral matching (BM) merge, an advanced motion vector prediction (AMVP)-merge, an adaptive decoder side motion vector refinement (ADMVR), a regular AMVP, or a TM-AMVP.

In some embodiments, the MV is determined based on the MVP list.

In some embodiments, determining the MVP list comprises: checking candidates in the further MVP list in order; and determining the MVP list based on the checking, wherein for a candidate among the candidates, determining the MVP list comprises: in accordance with a determination that the candidate satisfied a condition, adding the candidate in the MVP list.

In some embodiments, the condition comprises: the candidate is a uni-directional MVP candidate.

In some embodiments, the condition comprises: the candidate is a uni-directional MVP candidate or a bi-directional MVP candidate.

In some embodiments, the candidate of the second coding tool is reordered based on a second metric comprising a template matching cost.

In some embodiments, the top M candidates with the least M or highest M costs is included in the MVP list, wherein M is a positive integer.

In some embodiments, two different MVP lists are determined for intra block copy (IBC) bi-prediction and IBC blending respectively.

In some embodiments, the MV is determined based on a motion vector prediction (MVP) index in the bitstream.

In some embodiments, the MVP list is reordered based on a third metric comprising a template matching cost.

In some embodiments, the MV is determined based on top P candidates with the least P or highest P costs, P being a positive integer.

In some embodiments, the MV is determined based on a MVD or a merge mode with MVD (MMVD) index.

In some embodiments, no syntax is used to indicate a precision of the MVD, and wherein a fixed precision is used by an encoder and a decoder to indicate the precision of the MVD.

In some embodiments, an adaptive motion vector refinement (AMVR) index is used to express the precision of the MVD.

In some embodiments, the precision of the MVD is expressed based on a syntax in the bitstream.

In some embodiments, the intraprediction comprises at least one of: a conventional intra prediction, a decoder side intra mode derivation (DIMD), a template-based intra mode derivation (TIMD), a multi-reference line (MRL), an intra sub-partition coding (ISP), a matrix based intra prediction (MIP), an intra template matching prediction (IntraTMP), an intra prediction fusion, a spatial geometric partitioning mode (SGPM), a template-based multiple reference line intra prediction (TMRL), a position dependent (intra) prediction combination (PDPC) PDPC, a gradient PDPC, a cross-component linear model (CCLM), a multi-model based linear model (MMLM), a convolutional (cross-component model) CCCM, a gradient linear model (GLM), or a chroma fusion.

In some embodiments, the BVP list is determined based on a bi-predictive BVPs.

In some embodiments, a bi-predictive BVP comprises a plurality of BVs.

In some embodiments, the plurality of BVs of the bi-predictive BVP are the same.

In some embodiments, the plurality of BVs of the bi-predictive BVP are different.

In some embodiments, the bi-predictive BVP comprises BV and motion information.

In some embodiments, the motion information comprises at least one of: a MV, a reference index, or a reference list index.

In some embodiments, the motion information comprises at least one of: a MV and a fixed or derived reference frame.

In some embodiments, the method 2400 further comprises: in accordance with a determination that a BVP specified by a BVP index is bi-predictive, coding a block with bi-predictive intra block copy (IBC) or IBC blending.

In some embodiments, the method 2400 further comprises: in accordance with a determination that a BVP specified by a BVP index is uni-predictive, coding a block with uni-predictive intra block copy (IBC) or IBC blending.

In some embodiments, the bi-predictive BVP is determined based on at least one of: an adjacent spatial position, a non-adjacent spatial position, an adjacent temporal position, a non-adjacent temporal position or a table that stores history BVPs or MVPs.

In some embodiments, the BVP list is determined based on bi-predictive BVPs.

In some embodiments, the BVP list is determined based on uni-predictive BVPs.

In some embodiments, the BVP list is determined based on bi-predictive and uni-predictive BVPs.

In some embodiments, a plurality of BVP lists is determined, wherein at least one of the plurality of BVP lists is determined based on uni-predictive BVPs, at least one of the plurality of BVP lists is determined based on bi-predictive BVPs, and at least one of the plurality of BVP lists is determined based on bi-predictive and uni-predictive BVPs.

In some embodiments, the method 2400 further comprises: determining a hybrid list based on a motion vector prediction (MVP) and a BVP.

In some embodiments, a BVP list is determined based on at least one uni-predictive BVP and at least one bi-predictive BVP.

In some embodiments, the number of BVPs in the BVP list is less than or equal to a first maximum allowed number, the first maximum allowed number being a constant or a derived value.

In some embodiments, the number of uni-predictive BVPs in the BVP list is less than or equal to a second maximum allowed number, the second maximum allowed number being a constant or a derived value.

In some embodiments, the number of bi-predictive BVPs in the BVP list is less than or equal to a third maximum allowed number, the third maximum allowed number being a constant or a derived value.

In some embodiments, the BVP list is determined based on traversing BVP candidates in a predefined order.

In some embodiments, the BVP candidates comprises at least one of: an adjacent neighboring BVP, an adjacent neighboring BVP at a location, a temporal motion vector prediction (TMVP) BVP, a history-based motion vector prediction (HMVP) BVP, a non-adjacent spatial BVP, a non-adjacent temporal BVP, or a constructed BVP.

In some embodiments, the BVP candidates are added in the BVP list.

In some embodiments, a bi-predictive BVP and a uni-predictive BVP are assigned with different priority to be included in the BVP list.

In some embodiments, the bi-predictive BVP has higher or lower priority to be included in the BVP list than the uni-predictive BVP.

In some embodiments, the bi-predictive BVP is included in the BVP list after the uni-predictive BVP, or wherein the uni-predictive BVP is included in the BVP list after the bi-predictive BVP.

In some embodiments, if the number of uni-predictive BVPs in the BVP list is less than a constant or an adaptively derived value, a bi-predictive BVP is included in the BVP list, or if the number of bi-predictive BVPs in the BVP list is less than a constant or an adaptively derived value, a uni-predictive BVP is included in the BVP list.

In some embodiments, the BVP list is reordered based on a fourth metric comprising a template matching cost.

In some embodiments, for a uni-predictive BVP, a reference template is generated with uni-prediction.

In some embodiments, for a bi-predictive BVP, a reference template is generated with bi-prediction.

In some embodiments, a template matching cost of a bi-predictive BVP is determined before sorting with uni-predictive BVPs, or wherein a template matching cost of a uni-predictive BVP is determined before sorting with bi-predictive BVPs.

In some embodiments, the template matching cost is determined based on applying a linear or non-linear transform to an initial template matching cost.

In some embodiments, the BVP list is determined based on a pruning operation.

In some embodiments, if all BVPs in a BVD list are bi-predictive, a uni-predictive BVP is included in the BVP list without the pruning operation, or if all BVPs in a BVD list are uni-predictive, a bi-predictive BVP is included in the BVP list without the pruning operation.

In some embodiments, the method 2400 further comprises: in accordance with a determination that a uni-predictive BVP is different from at least one uni-predictive BVP in the BVP list, including the uni-predictive BVP in the BVP list.

In some embodiments, the method 2400 further comprises: in accordance with a determination that a uni-predictive BVP is different from at least one bi-predictive BVP in the BVP list, including the uni-predictive BVP in the BVP list.

In some embodiments, an absolute different of at least one component of two BVs is larger than a constant or an adaptively determined value, and the two BVs are determined to be different.

In some embodiments, an absolute different of each component of two BVs is larger than a constant or an adaptively determined value, and the two BVs are determined to be different.

In some embodiments, the constant is 0. In some embodiments, the constant is larger than 0.

In some embodiments, the final prediction is determined based on a weighted sum of the first and second predictions.

In some embodiments, a first weighting value of the first prediction is equal to a second weighting value of the second prediction.

In some embodiments, the first and second weighting values are predefined, and/or derived at a decoder for the conversion.

In some embodiments, the first and second weighting values are determined based on a cost value.

In some embodiments, the cost value is a sum of absolute differences between reconstruction samples and prediction samples on a template of the target video block.

In some embodiments, the first and second weighting values are determined based on an index in the bitstream at a decoder for the conversion.

In some embodiments, the method 2400 further comprises: conducting at least one of: local illumination compensation (LIC) or an overlapped block motion compensation (OBMC) to the first and second predictions before determining the final prediction.

In some embodiments, no local illumination compensation (LIC) or an overlapped block motion compensation (OBMC) is conducted to the first and second predictions.

In some embodiments, the method 2400 further comprises: conducting a filtering operation to the first and second predictions before determining the final prediction.

In some embodiments, conducting the filtering operation comprises: refining the first and second predictions based on a fix-shape filter of which a coefficient is determined based on a current template and a reference template, or a reconstructed template and predicted template.

In some embodiments, the first and second predictions are blended based on a constant weight.

In some embodiments, a weight index is included in the bitstream to specify a weight candidate in a set of weights.

In some embodiments, available weights in the set are included in one of: a dependency parameter set (DPS), a sequence parameter set (SPS), a video parameter set (VPS), a picture parameter set (PPS), an adaptation parameter sets (APS), a picture header, a slice header, or a tile group header.

In some embodiments, the available weights in the set are predefined in an encoder and a decoder for the conversion.

In some embodiments, the method 2400 further comprises: in accordance with a determination that the weight sets used by an encoder and a decoder for the conversion are the same, disabling the weight index.

In some embodiments, the first and second weighting values are determined based on a template.

In some embodiments, a prediction of a template region of a block is determined based on a same MV or BV, and a weight is determined based on a reconstruction and the prediction of the template region.

In some embodiments, the first and second weighting values are rounded to a fixed value.

In some embodiments, the first and second weighting values in a first position may be different from that of a second position.

In some embodiments, the first and second weighting values are derived.

In some embodiments, the first and second weighting values are derived using neighboring samples of the target video block.

In some embodiments, the first and second weighting values are determined based on an LDL or Gaussian elimination used in a convolutional cross-component model (CCCM).

In some embodiments, the first and second weighting values are determined based on a Least-Mean-Square (LMS).

In some embodiments, the first and second weighting values are determined based on an approach for determining a weight or a parameter for a further coding tool, the further coding tool comprising at least one of: a convolutional cross-component model (CCCM), a local illumination compensation (LIC), or a cross-component linear model (CCLM).

In some embodiments, a block vector difference (BVD) and a motion vector difference (MVD) for the target video block are included in the bitstream.

In some embodiments, a merge mode with block vector difference (MBVD) index and a merge mode with motion vector difference (MMVD) index for the target video block are included in the bitstream.

In some embodiments, a first syntax indicating whether to use bi-predictive intra block copy (IBC) or IBC blending is included in the bitstream, and wherein if the first syntax is true or false, a second syntax indicating whether BV or MV is used to generate a second predictor for the second prediction is included in the bitstream.

In some embodiments, the method 2400 further comprises: determining whether to apply the method based on a content characteristic, the content characteristic comprising a screen content or a natural content.

In some embodiments, the method is applied to a further coding tool, the further coding tool comprising an intra template matching prediction (IntraTMP).

In some embodiments, the target video block or a video unit comprises at least one of: a colour component, a sub-picture, a slice, a tile, a coding tree unit (CTU), a CTU row, a groups of CTU, a coding unit (CU), a prediction unit (PU), a transform unit (TU), a coding tree block (CTB), a coding block (CB), a prediction block(PB), a transform block (TB), a block, sub-block of a block, sub-region within a block, or a region that contains more than one sample or pixel.

In some embodiments, an indication of whether to and/or how to apply the method 2400 is indicated at one of: a sequence level, a group of pictures level, a picture level, a slice level, or a tile group level.

In some embodiments, an indication of whether to and/or how to apply the method 2400 is indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, whether to and/or how to apply the method 2400 is based on at least one of: a message included in one of: a dependency parameter set (DPS), a sequence parameter set (SPS), a video parameter set (VPS), a picture parameter set (PPS), an adaptation parameter sets (APS), a picture header, a slice header, a tile group header, a largest coding unit (LCU), a coding unit (CU), a LCU row, a group of LCUs, a transform unit (TU), a prediction unit (PU) block, or a video coding unit, a position of CU, PU, TU, block, or the video coding unit, a block dimension of the target video block and/or neighboring blocks of the target video block, a block shape of the target video block and/or neighboring blocks of the target video block, a coded mode of a block, an indication of a color format, a coding tree structure, a slice, tile group type and/or picture type, a colour component, a temporal layer identifier (ID), or profiles, levels, or tiers of a standard.

In some embodiments, the coded mode comprises one of: an intra block copy (IBC), a non-IBC inter mode, or a non-IBC subblock mode, or wherein the color format comprises one of: 4:2:0, or 4:4:4.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a first prediction of a target video block of the video based on a first block vector (BV); determining a final prediction of the target video block based on the first prediction and a second prediction of the target video block, the second prediction being determined based on at least one of: a second BV, a motion vector (MV), or an intra prediction; and generating the bitstream based on the final prediction.

According to still further embodiments of the present disclosure, a method for storing bitstream of a video is provided. The method comprises: determining a first prediction of a target video block of the video based on a first block vector (BV); determining a final prediction of the target video block based on the first prediction and a second prediction of the target video block, the second prediction being determined based on at least one of: a second BV, a motion vector (MV), or an intra prediction; generating the bitstream based on the final prediction; and storing the bitstream in a non-transitory computer-readable recording medium.

Implementations of the present disclosure can be described in view of the following clauses, the features of which can be combined in any reasonable manner.

Clause 1. A method for video processing, comprising: determining, for a conversion between a target video block of a video and a bitstream of the video, a first prediction of the target video block based on a first block vector (BV); determining a final prediction of the target video block based on the first prediction and a second prediction of the target video block, the second prediction being determined based on at least one of: a second BV, a motion vector (MV), or an intra prediction; and performing the conversion based on the final prediction.

Clause 2. The method of clause 1, wherein the final prediction is in a bi-predictive intra block copy (IBC) mode or a multi-hypothesis IBC mode.

Clause 3. The method of any of clauses 1-2, wherein the final prediction is determined based on blending the first and second predictions.

Clause 4. The method of any of clauses 1-3, wherein the final prediction is determined based on a block vector prediction (BVP) or a BVP list, wherein the BVP or the BVP list is determined based on re-using a further BVP or a further BVP list of a first coding tool.

Clause 5. The method of clause 4, wherein the first coding tool comprises at least one of: an intra block copy (IBC), an IBC merge mode with motion vector difference (MMVD), an IBC template matching (TM) mode, an IBC with geometric partitioning mode (GPM) (IBC-GPM), an IBC with local illumination compensation (LIC) (IBC-LIC), an IBC-combined intra and inter prediction mode (CIIP) (IBC-CIIP), an IBC-advanced motion vector prediction (AMVP), a TM based IBC-AMVP, an IBC merge mode with block vector difference (MBVD), a reconstruction-reordered IBC (RR-IBC), or a filter-based IBC.

Clause 6. The method of any of clauses 4-5, wherein the BVP or BVP list is different from the further BVP or further BVP list used for the first coding tool.

Clause 7. The method of any of clauses 1-3, wherein at least one of the first or second BV is determined based on a BV prediction (BVP) list.

Clause 8. The method of clause 7, wherein an index of a candidate BVP of the BVP list in the bitstream indicates the first BV.

Clause 9. The method of any of clauses 7-8, wherein the index is independently coded.

Clause 10. The method of any of clauses 7-8, wherein the index is determined based on another index of another BVP of the BVP list.

Clause 11. The method of clause 10, wherein the index is used as a prediction of the other index, and/or a difference of the index and the other index is included in the bitstream or parsed.

Clause 12. The method of any of clauses 7-11, wherein candidate BVPs of the BVP list is ordered based on a first metric comprising a template matching cost.

Clause 13. The method of any of clauses 7-12, wherein no index of candidate BVP in the BVP list is included in the bitstream, and top N candidate BVPs of the BVP list with the least N or highest N costs are used in determining the final prediction, wherein N is a positive integer.

Clause 14. The method of clause 13, wherein N is larger than or equal to 2.

Clause 15. The method of clause 13 or 14, wherein at least one index of at least one BVP in the BVP list is included in the bitstream, or at least one index of at least one BVP in the BVP list is adaptively derived.

Clause 16. The method of any of clauses 1-2, wherein at least one BV predictor for the target video block is determined based on a first candidate added with a first block vector difference (BVD) or a second candidate added with a second BVD indicated by a BVD index.

Clause 17. The method of clause 16, wherein the first candidate comprises an intra block copy-advanced motion vector prediction (IBC-AMVP) candidate, the second candidate comprises an IBC merge mode with block vector difference (IBC-MBVD) candidate, and the BVD index comprises a MBVD index.

Clause 18. The method of any of clauses 4-7, wherein at least one BV predictor for the target video block is determined based on a second block vector difference (BVD) indicated by a BVD index added with a candidate ABVP of the BVP list.

Clause 19. The method of clause 18, wherein the at least one BV predictor for the target video block is included in one of a dependency parameter set (DPS), a sequence parameter set (SPS), a video parameter set (VPS), a picture parameter set (PPS), an adaptation parameter sets (APS), a picture header, a slice header, or a tile group header in the bitstream.

Clause 20. The method of clause 18 or 19, wherein the at least one BV predictor for the target video block is specified by an encoder and a decoder for the conversion.

Clause 21. The method of clause 16, wherein at least one of the BVD index, the first BVD or the second BVD is indicated for all of the BVPs or the first BV of the target video block.

Clause 22. The method of any of clauses 16-21, wherein no syntax is used to indicate a precision of the first and second BVDs, and wherein a fixed precision is used by an encoder and a decoder to indicate the precision of the first and second BVDs.

Clause 23. The method of clause 22, wherein the fixed precision comprises an adaptive block vector resolution (ABVR) index or an adaptive motion vector resolution (AMVR) index.

Clause 24. The method of any of clauses 16-21, wherein a syntax in the bitstream indicates a precision of the first and second BVDs.

Clause 25. The method of any of clauses 16-18, wherein the BVP in the BVP list is used to generate prediction samples for BV predictors.

Clause 26. The method of any of clauses 2-4, wherein a universal BVP list is determined for a plurality of BV predictors.

Clause 27. The method of clause 26, further comprising: determining at least two different BVP lists for at least two different BV predictors.

Clause 28. The method of any of clauses 2-4, wherein prediction samples of at least one BVP are blended with prediction samples of at least one reconstructed reordered intra block copy (RR-IBC) predictor.

Clause 29. The method of any of clauses 2-4, wherein at least one BV predictor is refined by template matching, and a prediction sample of the target video block is determined based on the at least one refined BV predictor.

Clause 30. The method of clause 2, wherein at least the first and second BVs are stored for the target video block coded with bi-predictive intra block copy (IBC) or multi-hypothesis IBC.

Clause 31. The method of any of clauses 1-3, wherein the final prediction is determined based on the first prediction based on the first BV and the second prediction based on the MV in an intra block copy (IBC) blending mode.

Clause 32. The method of clause 31, wherein the second prediction is determined further based on at least one of: a motion vector prediction (MVP) index, a motion vector difference (MVD), a merge mode with MVD (MMVD) index, a reference index, or a reference list index.

Clause 33. The method of clause 31 or 32, wherein the first BV and the MV are stored for the target video block coded with IBC blending.

Clause 34. The method of any of claim 31-33, wherein the first BV is determined based on a BVP of a BVP list.

Clause 35. The method of clause 34, wherein the first BV is determined based on adding the BVP and a BVD.

Clause 36. The method of clause 34, wherein the BVD is expressed by including at least one of a horizontal component of the BVD, a vertical component of the BVD or a merge mode with BVD (MBVD) index in the bitstream.

Clause 37. The method of any of clauses 31-36, wherein the first BV is determined based on a BV predictor of the target video block.

Clause 38. The method of clause 32, further comprising: determining a motion vector prediction (MVP) list based on re-using or reforming a further MVP list of a second coding tool.

Clause 39. The method of clause 38, wherein the second coding tool comprises: a merge, a template matching (TM) merge, a bilateral matching (BM) merge, an advanced motion vector prediction (AMVP)-merge, an adaptive decoder side motion vector refinement (ADMVR), a regular AMVP, or a TM-AMVP.

Clause 40. The method of clause 38, wherein the MV is determined based on the MVP list.

Clause 41. The method of clause 38, wherein determining the MVP list comprises: checking candidates in the further MVP list in order; and determining the MVP list based on the checking, wherein for a candidate among the candidates, determining the MVP list comprises: in accordance with a determination that the candidate satisfied a condition, adding the candidate in the MVP list.

Clause 42. The method of clause 41, wherein the condition comprises: the candidate is a uni-directional MVP candidate.

Clause 43. The method of clause 41, wherein the condition comprises: the candidate is a uni-directional MVP candidate or a bi-directional MVP candidate.

Clause 44. The method of clause 38, wherein the candidate of the second coding tool is reordered based on a second metric comprising a template matching cost.

Clause 45. The method of clause 44, wherein the top M candidates with the least M or highest M costs is included in the MVP list, wherein M is a positive integer.

Clause 46. The method of clause 38, wherein two different MVP lists are determined for intra block copy (IBC) bi-prediction and IBC blending respectively.

Clause 47. The method of clause 32, wherein the MV is determined based on a motion vector prediction (MVP) index in the bitstream.

Clause 48. The method of clause 44, wherein the MVP list is reordered based on a third metric comprising a template matching cost.

Clause 49. The method of clause 48, wherein the MV is determined based on top P candidates with the least P or highest P costs, P being a positive integer.

Clause 50. The method of clause 32, wherein the MV is determined based on a MVD or a merge mode with MVD (MMVD) index.

Clause 51. The method of clause 32, wherein no syntax is used to indicate a precision of the MVD, and wherein a fixed precision is used by an encoder and a decoder to indicate the precision of the MVD.

Clause 52. The method of clause 51, wherein an adaptive motion vector refinement (AMVR) index is used to express the precision of the MVD.

Clause 53. The method of clause 32, wherein the precision of the MVD is expressed based on a syntax in the bitstream.

Clause 54. The method of clause 1, wherein the intra prediction comprises at least one of: a conventional intra prediction, a decoder side intra mode derivation (DIMD), a template-based intra mode derivation (TIMD), a multi-reference line (MRL), an intra sub-partition coding (ISP), a matrix based intra prediction (MIP), an intra template matching prediction (IntraTMP), an intra prediction fusion, a spatial geometric partitioning mode (SGPM), a template-based multiple reference line intra prediction (TMRL), a position dependent (intra) prediction combination (PDPC) PDPC, a gradient PDPC, a cross-component linear model (CCLM), a multi-model based linear model (MMLM), a convolutional (cross-component model) CCCM, a gradient linear model (GLM), or a chroma fusion.

Clause 55. The method of clause 4, wherein the BVP list is determined based on a bi-predictive BVPs.

Clause 56. The method of clause 55, wherein a bi-predictive BVP comprises a plurality of BVs.

Clause 57. The method of clause 56, wherein the plurality of BVs of the bi-predictive BVP are the same.

Clause 58. The method of clause 56, wherein the plurality of BVs of the bi-predictive BVP are different.

Clause 59. The method of clause 56, wherein the bi-predictive BVP comprises BV and motion information.

Clause 60. The method of clause 59, wherein the motion information comprises at least one of: a MV, a reference index, or a reference list index.

Clause 61. The method of clause 59, wherein the motion information comprises at least one of: a MV and a fixed or derived reference frame.

Clause 62. The method of clause 55, further comprising: in accordance with a determination that a BVP specified by a BVP index is bi-predictive, coding a block with bi-predictive intra block copy (IBC) or IBC blending.

Clause 63. The method of clause 55, further comprising: in accordance with a determination that a BVP specified by a BVP index is uni-predictive, coding a block with uni-predictive intra block copy (IBC) or IBC blending.

Clause 64. The method of any of clauses 55-59, wherein the bi-predictive BVP is determined based on at least one of: an adjacent spatial position, a non-adjacent spatial position, an adjacent temporal position, a non-adjacent temporal position or a table that stores history BVPs or MVPs.

Clause 65. The method of clause 55, wherein the BVP list is determined based on bi-predictive BVPs.

Clause 66. The method of clause 55, wherein the BVP list is determined based on uni-predictive BVPs.

Clause 67. The method of clause 55, wherein the BVP list is determined based on bi-predictive and uni-predictive BVPs.

Clause 68. The method of clause 55, wherein a plurality of BVP lists is determined, wherein at least one of the plurality of BVP lists is determined based on uni-predictive BVPs, at least one of the plurality of BVP lists is determined based on bi-predictive BVPs, and at least one of the plurality of BVP lists is determined based on bi-predictive and uni-predictive BVPs.

Clause 69. The method of clause 55, further comprising: determining a hybrid list based on a motion vector prediction (MVP) and a BVP.

Clause 70. The method of clause 67, wherein a BVP list is determined based on at least one uni-predictive BVP and at least one bi-predictive BVP.

Clause 71. The method of clause 70, wherein the number of BVPs in the BVP list is less than or equal to a first maximum allowed number, the first maximum allowed number being a constant or a derived value.

Clause 72. The method of clause 70, wherein the number of uni-predictive BVPs in the BVP list is less than or equal to a second maximum allowed number, the second maximum allowed number being a constant or a derived value.

Clause 73. The method of clause 70, wherein the number of bi-predictive BVPs in the BVP list is less than or equal to a third maximum allowed number, the third maximum allowed number being a constant or a derived value.

Clause 74. The method of any of clauses 70-73, wherein the BVP list is determined based on traversing BVP candidates in a predefined order.

Clause 75. The method of clause 74, wherein the BVP candidates comprises at least one of: an adjacent neighboring BVP, an adjacent neighboring BVP at a location, a temporal motion vector prediction (TMVP) BVP, a history-based motion vector prediction (HMVP) BVP, a non-adjacent spatial BVP, a non-adjacent temporal BVP, or a constructed BVP.

Clause 76. The method of clause 74, wherein the BVP candidates are added in the BVP list.

Clause 77. The method of clause 70, wherein a bi-predictive BVP and a uni-predictive BVP are assigned with different priority to be included in the BVP list.

Clause 78. The method of clause 77, wherein the bi-predictive BVP has higher or lower priority to be included in the BVP list than the uni-predictive BVP.

Clause 79. The method of clause 77, wherein the bi-predictive BVP is included in the BVP list after the uni-predictive BVP, or wherein the uni-predictive BVP is included in the BVP list after the bi-predictive BVP.

Clause 80. The method of clause 77, wherein if the number of uni-predictive BVPs in the BVP list is less than a constant or an adaptively derived value, a bi-predictive BVP is included in the BVP list, or if the number of bi-predictive BVPs in the BVP list is less than a constant or an adaptively derived value, a uni-predictive BVP is included in the BVP list.

Clause 81. The method of clause 70, the BVP list is reordered based on a fourth metric comprising a template matching cost.

Clause 82. The method of clause 81, wherein for a uni-predictive BVP, a reference template is generated with uni-prediction.

Clause 83. The method of clause 81, wherein for a bi-predictive BVP, a reference template is generated with bi-prediction.

Clause 84. The method of clause 81, wherein a template matching cost of a bi-predictive BVP is determined before sorting with uni-predictive BVPs, or wherein a template matching cost of a uni-predictive BVP is determined before sorting with bi-predictive BVPs.

Clause 85. The method of clause 81, wherein the template matching cost is determined based on applying a linear or non-linear transform to an initial template matching cost.

Clause 86. The method of clause 4, wherein the BVP list is determined based on a pruning operation.

Clause 87. The method of clause 86, wherein if all BVPs in a BVD list are bi-predictive, a uni-predictive BVP is included in the BVP list without the pruning operation, or if all BVPs in a BVD list are uni-predictive, a bi-predictive BVP is included in the BVP list without the pruning operation.

Clause 88. The method of clause 86, further comprising: in accordance with a determination that a uni-predictive BVP is different from at least one uni-predictive BVP in the BVP list, including the uni-predictive BVP in the BVP list.

Clause 89. The method of clause 86, further comprising: in accordance with a determination that a uni-predictive BVP is different from at least one bi-predictive BVP in the BVP list, including the uni-predictive BVP in the BVP list.

Clause 90. The method of clause 86, wherein an absolute different of at least one component of two BVs is larger than a constant or an adaptively determined value, and the two BVs are determined to be different.

Clause 91. The method of clause 86, wherein an absolute different of each component of two BVs is larger than a constant or an adaptively determined value, and the two BVs are determined to be different.

Clause 92. The method of clause 90 or 91, wherein the constant is 0.

Clause 93. The method of clause 90 or 91, wherein the constant is larger than 0.

Clause 94. The method of clause 1, wherein the final prediction is determined based on a weighted sum of the first and second predictions.

Clause 95. The method of clause 94, wherein a first weighting value of the first prediction is equal to a second weighting value of the second prediction.

Clause 96. The method of clause 94, wherein the first and second weighting values are predefined, and/or derived at a decoder for the conversion.

Clause 97. The method of clause 96, wherein the first and second weighting values are determined based on a cost value.

Clause 98. The method of clause 97, wherein the cost value is a sum of absolute differences between reconstruction samples and prediction samples on a template of the target video block.

Clause 99. The method of clause 96, wherein the first and second weighting values are determined based on an index in the bitstream at a decoder for the conversion.

Clause 100. The method of clause 94, further comprising: conducting at least one of: local illumination compensation (LIC) or an overlapped block motion compensation (OBMC) to the first and second predictions before determining the final prediction.

Clause 101. The method of clause 94, wherein no local illumination compensation (LIC) or an overlapped block motion compensation (OBMC) is conducted to the first and second predictions.

Clause 102. The method of clause 94, further comprising: conducting a filtering operation to the first and second predictions before determining the final prediction.

Clause 103. The method of clause 102, wherein conducting the filtering operation comprises: refining the first and second predictions based on a fix-shape filter of which a coefficient is determined based on a current template and a reference template, or a reconstructed template and predicted template.

Clause 104. The method of clause 94, wherein the first and second predictions are blended based on a constant weight.

Clause 105. The method of clause 104, wherein a weight index is included in the bitstream to specify a weight candidate in a set of weights.

Clause 106. The method of clause 105, wherein available weights in the set are included in one of: a dependency parameter set (DPS), a sequence parameter set (SPS), a video parameter set (VPS), a picture parameter set (PPS), an adaptation parameter sets (APS), a picture header, a slice header, or a tile group header.

Clause 107. The method of clause 106, wherein the available weights in the set are predefined in an encoder and a decoder for the conversion.

Clause 108. The method of clause 105, further comprising: in accordance with a determination that the weight sets used by an encoder and a decoder for the conversion are the same, disabling the weight index.

Clause 109. The method of clause 94, wherein the first and second weighting values are determined based on a template.

Clause 110. The method of clause 109, wherein a prediction of a template region of a block is determined based on a same MV or BV, and a weight is determined based on a reconstruction and the prediction of the template region.

Clause 111. The method of clause 110, the first and second weighting values are rounded to a fixed value.

Clause 112. The method of any of clauses 94-111, the first and second weighting values in a first position may be different from that of a second position.

Clause 113. The method of clause 94, wherein the first and second weighting values are derived.

Clause 114. The method of clause 113, wherein the first and second weighting values are derived using neighboring samples of the target video block.

Clause 115. The method of clause 113, wherein the first and second weighting values are determined based on an LDL or Gaussian elimination used in a convolutional cross-component model (CCCM).

Clause 116. The method of clause 113, wherein the first and second weighting values are determined based on a Least-Mean-Square (LMS).

Clause 117. The method of clause 113, wherein the first and second weighting values are determined based on an approach for determining a weight or a parameter for a further coding tool, the further coding tool comprising at least one of: a convolutional cross-component model (CCCM), a local illumination compensation (LIC), or a cross-component linear model (CCLM).

Clause 118. The method of any of clauses 1-117, wherein a block vector difference (BVD) and a motion vector difference (MVD) for the target video block are included in the bitstream.

Clause 119. The method of clause 118, wherein a merge mode with block vector difference (MBVD) index and a merge mode with motion vector difference (MMVD) index for the target video block are included in the bitstream.

Clause 120. The method of any of clauses 1-119, wherein a first syntax indicating whether to use bi-predictive intra block copy (IBC) or IBC blending is included in the bitstream, and wherein if the first syntax is true or false, a second syntax indicating whether BV or MV is used to generate a second predictor for the second prediction is included in the bitstream.

Clause 121. The method of clause 1, further comprising: determining whether to apply the method based on a content characteristic, the content characteristic comprising a screen content or a natural content.

Clause 122. The method of any of clauses 1-121, wherein the method is applied to a further coding tool, the further coding tool comprising an intra template matching prediction (IntraTMP).

Clause 123. The method of any of clauses 1-122, wherein the target video block or a video unit comprises at least one of: a colour component, a sub-picture, a slice, a tile, a coding tree unit (CTU), a CTU row, a groups of CTU, a coding unit (CU), a prediction unit (PU), a transform unit (TU), a coding tree block (CTB), a coding block (CB), a prediction block(PB), a transform block (TB), a block, sub-block of a block, sub-region within a block, or a region that contains more than one sample or pixel.

Clause 124. The method of any of clauses 1-123, wherein an indication of whether to and/or how to apply the method is indicated at one of: a sequence level, a group of pictures level, a picture level, a slice level, or a tile group level.

Clause 125. The method of any of clauses 1-123, wherein an indication of whether to and/or how to apply the method is indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 126. The method of any of clauses 1-123, wherein whether to and/or how to apply the method is based on at least one of: a message included in one of: a dependency parameter set (DPS), a sequence parameter set (SPS), a video parameter set (VPS), a picture parameter set (PPS), an adaptation parameter sets (APS), a picture header, a slice header, a tile group header, a largest coding unit (LCU), a coding unit (CU), a LCU row, a group of LCUs, a transform unit (TU), a prediction unit (PU) block, or a video coding unit, a position of CU, PU, TU, block, or the video coding unit, a block dimension of the target video block and/or neighboring blocks of the target video block, a block shape of the target video block and/or neighboring blocks of the target video block, a coded mode of a block, an indication of a color format, a coding tree structure, a slice, tile group type and/or picture type, a colour component, a temporal layer identifier (ID), or profiles, levels, or tiers of a standard.

Clause 127. The method of clause 126, wherein the coded mode comprises one of: an intra block copy (IBC), a non-IBC inter mode, or a non-IBC subblock mode, or wherein the color format comprises one of: 4:2:0, or 4:4:4.

Clause 128. The method of any of clauses 1-127, wherein the conversion comprises encoding the target video block into the bitstream.

Clause 129. The method of any of clauses 1-127, wherein the conversion comprises decoding the target video block from the bitstream.

Clause 130. An apparatus for video processing comprising a processor and a non-transitory memory with instructions thereon, wherein the instructions upon execution by the processor, cause the processor to perform a method in accordance with any of clauses 1-129.

Clause 131. A non-transitory computer-readable storage medium storing instructions that cause a processor to perform a method in accordance with any of clauses 1-129.

Clause 132. A non-transitory computer-readable recording medium storing a bitstream of a video which is generated by a method performed by an apparatus for video processing, wherein the method comprises: determining a first prediction of a target video block of the video based on a first block vector (BV); determining a final prediction of the target video block based on the first prediction and a second prediction of the target video block, the second prediction being determined based on at least one of: a second BV, a motion vector (MV), or an intra prediction; and generating the bitstream based on the final prediction.

Clause 133. A method for storing a bitstream of a video, comprising: determining a first prediction of a target video block of the video based on a first block vector (BV); determining a final prediction of the target video block based on the first prediction and a second prediction of the target video block, the second prediction being determined based on at least one of: a second BV, a motion vector (MV), or an intra prediction; generating the bitstream based on the final prediction; and storing the bitstream in a non-transitory computer-readable recording medium.

### Example Device

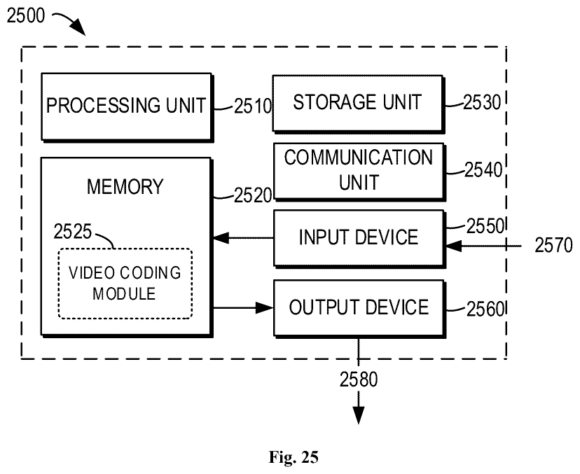

FIG. 25 illustrates a block diagram of a computing device 2500 in which various embodiments of the present disclosure can be implemented. The computing device 2500 may be implemented as or included in the source device 110 (or the video encoder 114 or 200) or the destination device 120 (or the video decoder 124 or 300).

It would be appreciated that the computing device 2500 shown in FIG. 25 is merely for purpose of illustration, without suggesting any limitation to the functions and scopes of the embodiments of the present disclosure in any manner.

As shown in FIG. 25, the computing device 2500 includes a general-purpose computing device 2500. The computing device 2500 may at least comprise one or more processors or processing units 2510, a memory 2520, a storage unit 2530, one or more communication units 2540, one or more input devices 2550, and one or more output devices 2560.

In some embodiments, the computing device 2500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2500 can support any type of interface to a user (such as “wearable” circuitry and the like).

The processing unit 2510 may be a physical or virtual processor and can implement various processes based on programs stored in the memory 2520. In a multi-processor system, multiple processing units execute computer executable instructions in parallel so as to improve the parallel processing capability of the computing device 2500. The processing unit 2510 may also be referred to as a central processing unit (CPU), a microprocessor, a controller or a microcontroller.

The computing device 2500 typically includes various computer storage medium. Such medium can be any medium accessible by the computing device 2500, including, but not limited to, volatile and non-volatile medium, or detachable and non-detachable medium. The memory 2520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2530 may be any detachable or non-detachable medium and may include a machine-readable medium such as a memory, flash memory drive, magnetic disk or another other media, which can be used for storing information and/or data and can be accessed in the computing device 2500.

The computing device 2500 may further include additional detachable/non-detachable, volatile/non-volatile memory medium. Although not shown in FIG. 25, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2540 communicates with a further computing device via the communication medium. In addition, the functions of the components in the computing device 2500 can be implemented by a single computing cluster or multiple computing machines that can communicate via communication connections. Therefore, the computing device 2500 can operate in a networked environment using a logical connection with one or more other servers, networked personal computers (PCs) or further general network nodes.

The input device 2550 may be one or more of a variety of input devices, such as a mouse, keyboard, tracking ball, voice-input device, and the like. The output device 2560 may be one or more of a variety of output devices, such as a display, loudspeaker, printer, and the like. By means of the communication unit 2540, the computing device 2500 can further communicate with one or more external devices (not shown) such as the storage devices and display device, with one or more devices enabling the user to interact with the computing device 2500, or any devices (such as a network card, a modem and the like) enabling the computing device 2500 to communicate with one or more other computing devices, if required. Such communication can be performed via input/output (I/O) interfaces (not shown).

In some embodiments, instead of being integrated in a single device, some or all components of the computing device 2500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2500 may be used to implement video encoding/decoding in embodiments of the present disclosure. The memory 2520 may include one or more video coding modules 2525 having one or more program instructions. These modules are accessible and executable by the processing unit 2510 to perform the functionalities of the various embodiments described herein.

In the example embodiments of performing video encoding, the input device 2550 may receive video data as an input 2570 to be encoded. The video data may be processed, for example, by the video coding module 2525, to generate an encoded bitstream. The encoded bitstream may be provided via the output device 2560 as an output 2580.

In the example embodiments of performing video decoding, the input device 2550 may receive an encoded bitstream as the input 2570. The encoded bitstream may be processed, for example, by the video coding module 2525, to generate decoded video data. The decoded video data may be provided via the output device 2560 as the output 2580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a target video block of a video and a bitstream of the video, a first prediction of the target video block based on a first block vector (BV);
determining a final prediction of the target video block based on the first prediction and a second prediction of the target video block, the second prediction being determined based on at least one of: a second BV, a motion vector (MV), or an intra prediction; and
performing the conversion based on the final prediction.

2. The method of claim 1, wherein the final prediction is in a bi-predictive intra block copy (IBC) mode or a multi-hypothesis IBC mode, and/or
wherein the final prediction is determined based on blending the first and second predictions.

3. The method of claim 1, wherein the final prediction is determined based on a block vector prediction (BVP) or a BVP list, wherein the BVP or the BVP list is determined based on re-using a further BVP or a further BVP list of a first coding tool,
wherein the first coding tool comprises at least one of: an intra block copy (IBC), an IBC merge mode with motion vector difference (MMVD), an IBC template matching (TM) mode, an IBC with geometric partitioning mode (GPM) (IBC-GPM), an IBC with local illumination compensation (LIC) (IBC-LIC), an IBC-combined intra and inter prediction mode (CIIP) (IBC-CIIP), an IBC-advanced motion vector prediction (AMVP), a TM based IBC-AMVP, an IBC merge mode with block vector difference (MBVD), a reconstruction-reordered IBC (RR-IBC), or a filter-based IBC, and/or
wherein the BVP or BVP list is different from the further BVP or further BVP list used for the first coding tool.

4. The method of claim 1, wherein at least one of the first or second BV is determined based on a BV prediction (BVP) list, wherein an index of a candidate BVP of the BVP list in the bitstream indicates the first BV.

5. The method of claim 4, wherein the index is independently coded.

6. The method of claim 4, wherein the index is determined based on another index of another BVP of the BVP list, wherein the index is used as a prediction of the other index, and/or a difference of the index and the other index is included in the bitstream or parsed.

7. The method of claim 4, wherein candidate BVPs of the BVP list is ordered based on a first metric comprising a template matching cost, and/or
wherein no index of candidate BVP in the BVP list is included in the bitstream, and top N candidate BVPs of the BVP list with the least N or highest N costs are used in determining the final prediction, wherein N is a positive integer, wherein N is larger than or equal to 2, wherein at least one index of at least one BVP in the BVP list is included in the bitstream, or at least one index of at least one BVP in the BVP list is adaptively derived.

8. The method of claim 1, wherein at least one BV predictor for the target video block is determined based on a first candidate added with a first block vector difference (BVD) or a second candidate added with a second BVD indicated by a BVD index,
wherein the first candidate comprises an intra block copy-advanced motion vector prediction (IBC-AMVP) candidate, and the second candidate comprises an IBC merge mode with block vector difference (IBC-MBVD) candidate, and the BVD index comprises a MBVD index.

9. The method of claim 3, wherein at least one BV predictor for the target video block is determined based on a second block vector difference (BVD) indicated by a BVD index added with a candidate ABVP of the BVP list,
wherein the at least one BV predictor for the target video block is included in one of a dependency parameter set (DPS), a sequence parameter set (SPS), avideo parameter set (VPS), apicture parameter set (PPS), an adaptation parameter sets (APS), apicture header, a slice header, or a tile group header in the bitstream, and/or
wherein the at least one BV predictor for the target video block is specified by an encoder and a decoder for the conversion.

10. The method of claim 8, wherein at least one of the BVD index, the first BVD or the second BVD is indicated for all of the BVPs or the first BV of the target video block,
wherein no syntax is used to indicate a precision of the first and second BVDs, and wherein a fixed precision is used by an encoder and a decoder to indicate the precision of the first and second BVDs, wherein the fixed precision comprises an adaptive block vector resolution (ABVR) index or an adaptive motion vector resolution (AMVR) index, or
wherein a syntax in the bitstream indicates a precision of the first and second BVDs.

11. The method of claim 8, wherein the BVP in the BVP list is used to generate prediction samples for BV predictors.

12. The method of claim 2, wherein a universal BVP list is determined for a plurality of BV predictors,
wherein the method further comprises: determining at least two different BVP lists for at least two different BV predictors.

13. The method of claim 2, wherein prediction samples of at least one BVP are blended with prediction samples of at least one reconstructed reordered intra block copy (RR-IBC) predictor, or
wherein at least one BV predictor is refined by template matching, and a prediction sample of the target video block is determined based on the at least one refined BV predictor.

14. The method of claim 2, wherein at least the first and second BVs are stored for the target video block coded with bi-predictive intra block copy (IBC) or multi-hypothesis IBC.

15. The method of claim 1, wherein the intra prediction comprises at least one of:
a conventional intra prediction, a decoder side intra mode derivation (DIMD), a template-based intra mode derivation (TIMD), a multi-reference line (MRL), an intra sub-partition coding (ISP), a matrix based intra prediction (MIP), an intra template matching prediction (IntraTMP), an intra prediction fusion, a spatial geometric partitioning mode (SGPM), a template-based multiple reference line intra prediction (TMRL), a position dependent (intra) prediction combination (PDPC) PDPC, a gradient PDPC, a cross-component linear model (CCLM), a multi-model based linear model (MMLM), a convolutional (cross-component model) CCCM, a gradient linear model (GLM), or a chroma fusion.

16. The method of claim 1, further comprising: determining whether to apply the method based on a content characteristic, the content characteristic comprising a screen content or a natural content.

17. The method of claim 1, wherein the conversion comprises encoding the target video block into the bitstream, or
wherein the conversion comprises decoding the target video block from the bitstream.

18. An apparatus for video processing comprising a processor and a non-transitory memory with instructions thereon, wherein the instructions upon execution by the processor, cause the processor to:
determine, for a conversion between a target video block of a video and a bitstream of the video, a first prediction of the target video block based on a first block vector (BV);
determine a final prediction of the target video block based on the first prediction and a second prediction of the target video block, the second prediction being determined based on at least one of: a second BV, a motion vector (MV), or an intra prediction; and
perform the conversion based on the final prediction.

19. A non-transitory computer-readable storage medium storing instructions that cause a processor to perform acts comprising:
determining, for a conversion between a target video block of a video and a bitstream of the video, a first prediction of the target video block based on a first block vector (BV);
determining a final prediction of the target video block based on the first prediction and a second prediction of the target video block, the second prediction being determined based on at least one of: a second BV, a motion vector (MV), or an intra prediction; and
performing the conversion based on the final prediction.

20. A non-transitory computer-readable recording medium storing a bitstream of a video which is generated by a method performed by an apparatus for video processing, wherein the method comprises:
determining a first prediction of a target video block of the video based on a first block vector (BV);
determining a final prediction of the target video block based on the first prediction and a second prediction of the target video block, the second prediction being determined based on at least one of: a second BV, a motion vector (MV), or an intra prediction; and
generating the bitstream based on the final prediction.
